(19) United States
(12) Patent Application Publication
(10) Pub. No.: US 2022/0347597 A1
(43) Pub. Date: Nov. 3, 2022

(54) METHOD OF FORMING SELF-ASSEMBLED NANOSTRUCTURES

(71) Applicant: Roya Dastjerdi, Yazd (IR)

(72) Inventor: Roya Dastjerdi, Yazd (IR)

(21) Appl. No.: 17/863,951

(22) Filed: Jul. 13, 2022

Related U.S. Application Data
(63) Continuation-in-part of application No. PCT/IB2021/061388, filed on Dec. 7, 2021.
(60) Provisional application No. 63/213,769, filed on Jun. 23, 2021.

(51) Int. Cl. B01D 11/02; C08G 83/00

(52) U.S. Cl. CPC B01D 11/0265; B01D 11/0288; C08G 83/003; C08G 83/008; B82Y 40/00

(57) ABSTRACT

A method for forming self-assembled inorganic nanostructures. The method includes forming a mixture by adding a plurality of inorganic nanostructures to an aqueous solution under atmospheric pressure. Forming the mixture includes adding a first plurality of inorganic nanostructures to the aqueous solution and adding a second plurality of inorganic nanostructures to the aqueous solution. The first plurality of inorganic nanostructures has a first plurality of superficial sites with an opposite-signed surface zeta potential respective to a surface zeta potential of a second plurality of superficial sites of the second plurality of inorganic nanostructures.

### CROSS-REFERENCE TO RELATED APPLICATION

This application is a continuation-in-part of International Patent Application PCT/IB2021/061388, filed on Dec. 7, 2021, and entitled “METHOD OF FORMING SELF-ASSEMBLED NANOSTRUCTURES”, which takes priority from U.S. Provisional Patent Application Ser. No. 63/213,769, filed on Jun. 23, 2021, and entitled “ENGINEERING OF NANOSTRUCTURES FAST AND GREEN SELF ASSEMBLING”, which are both incorporated herein by reference in their entirety.

### TECHNICAL FIELD

The present disclosure generally relates to a method for producing self-assembled nanostructures in an aqueous solution and at atmospheric pressure, and more particularly, relates to a method for producing self-assembled nanostructures using electrostatic interactions as a driving force.

### BACKGROUND

Nanomaterial is a category of materials with at least one dimension between 1 to 100 nm at least in one of their structures or components. Nanomaterial may have distinct properties such as high surface to volume ratio, high surface energy, and surface charge density values. Therefore, due to nanomaterial's distinct properties, nanomaterial may be used in biomedicine, sensors, biocatalytic purifications, dye removal processes, textile engineering, etc.

Nanomaterial may be produced by one of a top-down approach and a bottom-up approach. The top-down approach may include photolithography, scanning lithography, laser machining, printing, ion implantation, and deposition. The top-down approach may suffer from several limitations such as high cost of production, long etching times, and imperfections in the final products' structure. The bottom-up approach may include a gas-phase approach and a liquid-phase approach such as chemical vapor deposition, laser pyrolysis, molecular beam epitaxy, sol gel, wet synthesis, and self-assembly processes. The bottom-up approach may also have drawbacks such as usage of toxic chemicals, producing environmental pollutions, and multi-step of purifications which is costly and time-consuming.

Recently, bottom-up approaches have become one of the most exciting approaches to produce nanostructures. According to bottom-up approaches Ag/SiO₂ can be produced using tetraethyl orthosilicate and AgNO₃ as precursors in a media containing ethanol and ammonia. Sol gel method can also be used to produce Ag/TiO₂/SiO₂ nanostructures using organic solvents, such as ethanol, isopropanol, and tetraethyl orthosilicate at 150° C. Bottom-up approaches require organic solvents to produce nanostructures. Organic solvents can pollute water and therefore, harm the environment. Moreover, using organic solvents and additives such as emulsifiers can be expensive for industrial production.

There is, therefore, a need for a cost-effective, environmentally friendly, and fast method to produce self-assembled nanostructures with high surface area under atmospheric pressure. There is further a need for a method to produce self-assembled nanostructures with desired arrangements in an aqueous solution.

### SUMMARY

This summary is intended to provide an overview of the subject matter of this patent, and is not intended to identify essential elements or key elements of the subject matter, nor is it intended to be used to determine the scope of the claimed implementations. The proper scope of this patent may be ascertained from the claims set forth below in view of the detailed description below and the drawings.

According to one or more exemplary embodiments, the present disclosure is directed to a method for forming self-assembled inorganic nanostructures. An exemplary method may include forming a first mixture by adding a plurality of inorganic nanostructures to an aqueous solution at a weight ratio in a range of 0.001:100 to 40:100 (an exemplary plurality of inorganic nanostructures: an exemplary aqueous solution). Forming an exemplary first mixture may include adding a first plurality of inorganic nanostructures of a metal, a metal oxide, a metal hydroxide, Silicon (Si), Boron (B), Silicon dioxide (SiO₂), a salt, a composite, clays, layered double hydroxides (LDHs), MXenes, magnetites, graphene, graphene oxide, reduced graphene oxide, carbon nanotubes (CNTs), fullerene, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof to an exemplary aqueous solution at atmospheric pressure and a temperature of at least 2° C. Then adding a second plurality of inorganic nanostructures to an exemplary aqueous solution. In an exemplary embodiment, an exemplary first plurality of inorganic nanostructures may include a first plurality of superficial sites with opposite-signed surface zeta potential respective to a surface zeta potential of a second plurality of superficial sites of an exemplary second plurality of inorganic nanostructures. An exemplary second plurality of inorganic nanostructures may include a metal, a metal oxide, a metal hydroxide, Silicon (Si), Boron (B), Silicon dioxide (SiO₂), a salt, a composite, clays, layered double hydroxides (LDHs), MXenes, magnetites, graphene, graphene oxide, reduced graphene oxide, carbon nanotubes (CNTs), fullerene, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof.

In an exemplary embodiment, adding an exemplary first plurality of inorganic nanostructures to an exemplary aqueous solution may include adding an exemplary first plurality of inorganic nanostructures to at least one of distilled water, deionized water, municipal water, water with total dissolved solids (TDS) of between 1 ppm and 50000 ppm, recycled water, and combinations thereof.

In an exemplary embodiment, forming an exemplary first mixture may further include homogenizing an exemplary first mixture at an exemplary predetermined condition utilizing an ultrasonic device with a sonication power of at least 5 kJ for at least 10 seconds.

In an exemplary embodiment, forming self-assembled inorganic nanostructures may further include forming a second mixture by adding a third plurality of inorganic nanostructures to an exemplary aqueous solution at a concentration of at least 5 ppm at atmospheric pressure and a temperature of at least 2° C. An exemplary third plurality of inorganic nanostructures may include at least one of a metal, a metal oxide, a metal hydroxide, Silicon (Si), Boron (B), Silicon dioxide (SiO₂), a salt, a composite, clays, layered double hydroxides (LDHs), MXenes, magnetites, graphene, graphene oxide, reduced graphene oxide, carbon nanotubes (CNTs), fullerene, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof. An exemplary third plurality of inorganic nanostructures may include a third plurality of superficial sites with opposite-signed surface zeta potential respective to a surface zeta potential of at least one of an exemplary first plurality of superficial sites and an exemplary second plurality of superficial sites of an exemplary formed self-assembled inorganic nanostructures of an exemplary plurality of inorganic nanostructures at atmospheric pressure and a temperature of at least 2° C.

In an exemplary embodiment, an exemplary metal may include at least one of Silver (Ag), Copper (Cu), Platinum (Pt), gold (Au), Manganese (Mn), Tin (Sn), Fe, Lead (Pb), Iridium (Ir), Cobalt (Co), Tellurium (Te), Nickel (Ni), Niobium (Nb), Vanadium (V), Tungsten (W), and combinations thereof.

In an exemplary embodiment, an exemplary metal oxide and metal hydroxide may include at least one of Titanium dioxide (TiO₂), Zinc oxide (ZnO), Copper oxide (CuO), Iron oxide (Fe₂O₃), Iron oxide Fe₃O₄, Magnesium oxide (MgO), Magnesium hydroxide (MgOH), and combinations thereof.

In an exemplary embodiment, an exemplary salt may include at least one of Calcium carbonate (CaCO₃), Silicon carbide (SiC), Iron phosphorus trisulfide (FePS₃), Strontium stannate (SrSno₃), Tungsten ditelluride (WTe₂), Potassium heptafluorotantalate (K₂TaF₇), Tungsten disulfide (WS₂), Magnesium diboride (MgB₂), Niobium disulfide (NbS₂), transition metal chalcogenides (TMCs), and combinations thereof.

In an exemplary embodiment, an exemplary composite may include at least one of Silver/Zinc oxide (Ag/ZnO), Silver/Silicon dioxide (Ag/SiO₂), Silver/Titanium dioxide (Ag/TiO₂), and combinations thereof.

In an exemplary embodiment, forming an exemplary second mixture may further include homogenizing an exemplary third plurality of inorganic nanostructures with an exemplary first mixture, utilizing an ultrasonic device with a sonication power of at least 5 kJ for at least 10 seconds.

According to one or more exemplary embodiments, the present disclosure is directed to a method for nanofunctionalizing a fabric with inorganic nanostructures. An exemplary method may include forming a mixture of a plurality of self-assembled inorganic nanostructures by adding a plurality of inorganic nanostructures to an aqueous solution at a weight ratio in a range of 0.001:100 to 40:100 (an exemplary plurality of inorganic nanostructures: an exemplary aqueous solution), adding a first plurality of inorganic nanostructures of at least one of a metal, a metal oxide and metal hydroxide, Silicon (Si), Boron (B), Silicon dioxide (SiO₂), a salt, a composite, clays, layered double hydroxides (LDHs), MXenes, magnetites, carbon nanotubes (CNTs), fullerene, graphene, graphene oxide, reduced graphene oxide, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof to an exemplary aqueous solution at atmospheric pressure and a temperature of at least 2° C. and adding a second plurality of inorganic nanostructures to an exemplary aqueous solution. In an exemplary embodiment, an exemplary second plurality of inorganic nanostructures may include a second plurality of superficial sites with opposite-signed surface zeta potential respective to a surface zeta potential of a first plurality of superficial sites of an exemplary first plurality of inorganic nanostructures. An exemplary second plurality of inorganic nanostructures may include at least one of a metal, a metal oxide and a metal hydroxide, Silicon (Si), Boron (B), Silicon dioxide (SiO₂), a salt, a composite, clays, layered double hydroxides (LDHs), MXenes, magnetites, carbon nanotubes (CNTs), fullerene, graphene, graphene oxide, reduced graphene oxide, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof. An exemplary method for nanofunctionalizing a fabric with inorganic nanostructures may further include depositing an exemplary plurality of self-assembled inorganic nanostructures on an exemplary fabric by immersing an exemplary fabric into an exemplary mixture of an exemplary plurality of self-assembled inorganic nanostructures for at least 3 seconds. An exemplary method for nanofunctionalizing a fabric with inorganic nanostructures may further include retaining the moisture of an exemplary fabric in an exemplary mixture at a wet-pick-up percent in a range of 10% to 350%. An exemplary method for nanofunctionalizing a fabric with inorganic nanostructures may further include drying an exemplary fabric in a heater at a temperature of between 20° C. and 200° C. for at least 30 seconds.

In an exemplary embodiment, adding an exemplary first plurality of inorganic nanostructures to an exemplary aqueous solution and adding an exemplary second plurality of inorganic nanostructures to an exemplary aqueous solution may further include homogenizing an exemplary aqueous solution containing an exemplary added first plurality of inorganic nanostructures and/or the added second plurality of inorganic nanostructures using an ultrasonic device at atmospheric pressure and a temperature of at least 2° C. for at least 10 seconds with a sonication power of at least 5 kJ.

In an exemplary embodiment, immersing an exemplary fabric into an exemplary mixture of an exemplary plurality of self-assembled inorganic nanostructures may include loading inorganic nanostructures to an exemplary fabric at a weight ratio in a range of 0.001:100 to 300:100 (an exemplary plurality of self-assembled inorganic nanostructures: an exemplary fabric).

In an exemplary embodiment, an exemplary method for nanofunctionalizing an exemplary fabric with inorganic nanostructures may further include coating an exemplary nanofunctionalized fabric with a resin. An exemplary method of coating an exemplary nanofunctionalized fabric with an exemplary resin may include depositing a resin on an exemplary nanofunctionalized fabric by immersing an exemplary nanofunctionalized fabric into an exemplary resin. In an exemplary embodiment, an exemplary resin may include at least one of acrylic resins, silicones, polysiloxanes, polyurethanes, poly(vinyl acetates) (PVA), polyvinylpyrrolidone (PVP), polyamide (PA), polyethylene oxide (PEO), polyols, n-methylols, polyesters, protein compounds, polysaccharides, carbohydrates, polyelectrolytes, hydrogels, poly(sodium acrylate), polyimides, poly(amidoamine) (PAMAMs), polyaniline, and polyvinylidene fluoride (PVdF), and combinations thereof. An exemplary method of coating an exemplary nanofunctionalized fabric with an exemplary resin may further include retaining an exemplary resin on an exemplary nanofunctionalized fabric with a wet-pick-up percent in a range of 10% to 300% and drying an exemplary fabric in a heater at a temperature of between 20° C. and 200° C. for at least 30 seconds.

In an exemplary embodiment, depositing an exemplary resin on an exemplary nanofunctionalized fabric may include immersing an exemplary nanofunctionalized fabric into an exemplary resin for at least 1 seconds.

In an exemplary embodiment, depositing an exemplary resin on an exemplary nanofunctionalized fabric may include coating an exemplary nanofunctionalized fabric with an exemplary resin at a weight ratio of 0.03:100 to 50:100 (an exemplary resin: an exemplary nanofunctionalized fabric).

In an exemplary embodiment, depositing an exemplary resin on an exemplary nanofunctionalized fabric may include coating an exemplary nanofunctionalized fabric with an exemplary resin. Coating an exemplary nanofunctionalized fabric with an exemplary resin may include spray coating an exemplary nanofunctionalized fabric with an exemplary resin for at least 0.2 s.

In an exemplary embodiment, spray coating an exemplary nanofunctionalized fabric with an exemplary resin may include spray coating an exemplary nanofunctionalized fabric with a resin solution at a weight ratio in a range of 0.0003:1 to 2:1 (resin:solvent).

In an exemplary embodiment, forming an exemplary mixture of an exemplary plurality of self-assembled inorganic nanostructures may further include forming a second mixture by adding a third plurality of inorganic nanostructures to an exemplary aqueous solution at a concentration of at least 5 ppm at atmospheric pressure and a temperature of at least 2° C. In an exemplary embodiment, an exemplary third plurality of inorganic nanostructures may include a plurality of at least one of a metal, a metal oxide and a metal hydroxide, Silicon (Si), Boron (B), Silicon dioxide (SiO₂), a salt, a composite, clays, layered double hydroxides (LDHs), MXenes, magnetites, carbon nanotubes (CNTs), fullerene, graphene, graphene oxide, reduced graphene oxide, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof. In an exemplary embodiment, an exemplary third plurality of inorganic nanostructures may include a third plurality of superficial sites with opposite-signed surface zeta potential respective to a surface zeta potential of at least one of an exemplary first plurality of superficial sites and an exemplary second plurality of superficial sites of an exemplary formed self-assembled inorganic nanostructures of an exemplary plurality of inorganic nanostructures at atmospheric pressure and a temperature of at least 2° C.

In an exemplary embodiment, adding an exemplary third plurality of inorganic nanostructures to an exemplary aqueous solution may further include homogenizing an exemplary third plurality of inorganic nanostructures with an exemplary aqueous solution utilizing an ultrasonic device with a sonication power of at least 5 kJ for at least 10 seconds.

In an exemplary embodiment, adding the plurality of inorganic nanostructures to the aqueous solution may include adding the plurality of inorganic nanostructures to at least one of distilled water, deionized water, municipal water, water with total dissolved solids (TDS) of between 1 ppm and 50000 ppm, recycled water, and combinations thereof. In an exemplary embodiment, adding each of an exemplary first plurality of inorganic nanostructures, an exemplary second plurality of inorganic nanostructures, and an exemplary third plurality of inorganic nanostructures to an exemplary aqueous solution may include adding each of an exemplary first plurality of inorganic nanostructures, an exemplary second plurality of inorganic nanostructures, and an exemplary third plurality of inorganic nanostructures to at least one of distilled water, deionized water, municipal water, water with total dissolved solids (TDS) of between 1 ppm and 50000 ppm, recycled water, and combinations thereof.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1A shows a flowchart of an exemplary method for forming self-assembled inorganic nanostructures, consistent with one or more exemplary embodiments of the present disclosure;

FIG. 1B shows a flowchart of another exemplary method for forming self-assembled inorganic nanostructures, consistent with one or more exemplary embodiments of the present disclosure;

FIG. 1C shows a flowchart of a method for nanofunctionalizing a fabric with self-assembled inorganic nanostructures, consistent with one or more exemplary embodiments of the present disclosure;

FIG. 2A shows a schematic view of exemplary formed flower-shaped self-assembled nanostructures of an exemplary first plurality of inorganic nanostructures and an exemplary second plurality of nanostructures, consistent with one or more exemplary embodiments of the present disclosure;

FIG. 2B shows a schematic view of exemplary star-shaped TiO₂/Ag/SiO₂ self-assembled nanostructures, consistent with one or more exemplary embodiments of the present disclosure;

FIG. 3A shows a scanning electron microscopy (SEM) image of exemplary flower-shaped Ag/SiO₂ nanostructures on a fabric, consistent with one or more exemplary embodiments of the present disclosure;

FIG. 3B shows SEM images of exemplary star-shaped TiO₂/Ag/SiO₂ nanostructures on a fabric, consistent with one or more exemplary embodiments of the present disclosure;

FIG. 4 shows a chart representing results of a bending test applied on fabrics treated by the colloidal solutions of exemplary flower-shaped nanostructures and star-shaped nanostructures, and a control sample, consistent with one or more exemplary embodiments of the present disclosure;

FIG. 5 shows a chart representing results of a crease recovery angle test applied on fabrics treated by colloidal solutions of exemplary flower-shaped nanostructures and star-shaped nanostructures, and a control sample, consistent with one or more exemplary embodiments of the present disclosure;

FIG. 6 shows a chart representing results of a UV protection test applied on fabrics treated by colloidal solutions of exemplary flower-shaped nanostructures and star-shaped nanostructures, and a control sample, consistent with one or more exemplary embodiments of the present disclosure;

FIG. 7 shows a chart representing results of a reflectance assessment test applied on fabrics treated by colloidal solutions of exemplary flower-shaped nanostructures and star-shaped nanostructures, and a control sample, consistent with one or more exemplary embodiments of the present disclosure;

FIG. 8 shows a chart representing results of a stain removal assessment test applied on fabrics treated by colloidal solutions of exemplary flower-shaped nanostructures and star-shaped nanostructures, and a control sample, consistent with one or more exemplary embodiments of the present disclosure;

FIG. 9 shows a chart representing results of a staining assessment test applied on fabrics treated by colloidal solutions of exemplary flower-shaped nanostructures and star-shaped nanostructures, and a control sample, consistent with one or more exemplary embodiments of the present disclosure;

FIG. 10 shows a chart representing results of a biocompatibility test applied on fabrics treated by colloidal solutions of exemplary flower-shaped nanostructures and star-shaped nanostructures, and a control sample, consistent with one or more exemplary embodiments of the present disclosure;

FIG. 11 shows a chart representing results of an antibacterial activity test applied on fabrics treated by colloidal solutions of exemplary flower-shaped nanostructures and star-shaped nanostructures, and a control sample, consistent with one or more exemplary embodiments of the present disclosure;

FIG. 12 shows a chart representing results of a wear resistance test applied on fabrics treated by colloidal solutions of exemplary formed self-assembled nanostructures before sun radiation and after sun radiation, consistent with one or more exemplary embodiments of the present disclosure; and

FIG. 13 shows a chart representing results of a resistant abrasion cycle test applied on fabrics treated by colloidal solution of exemplary formed self-assembled nanostructures and fabrics with no treatment, consistent with one or more exemplary embodiments of the present disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The novel features which are believed to be characteristic of the present disclosure, as to its structure, organization, use and method of operation, together with further objectives and advantages thereof, will be better understood from the following discussion.

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings. The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

Nanostructures may be materials comprising at least one component with at least one dimension in a scale of 100 nm with superior properties, such as high surface to volume ratio, high surface energy, and surface charge density values. Nanostructures may be produced by methods requiring toxic organic solvents, high energy and a long period of producing time. The present disclosure is directed to exemplary embodiments of a method to form self-assembled inorganic nanostructures. Exemplary self-assembled inorganic nanostructures may be produced under atmospheric pressure and atmosphere using an aqueous solution to minimize harmful effects of organic solvents on the environment.

In an exemplary embodiment, to control arrangements of exemplary inorganic nanostructures, mixtures of aqueous solutions of inorganic nanostructures may be prepared. To form an exemplary self-assembled inorganic nanostructure, a plurality of inorganic nanostructures may be used. An exemplary inorganic nanostructures may include different forms or shapes of nanostructures, such as nanoplate, nanofiber, nanotube, nanoparticle, etc. An exemplary formed self-assembled inorganic nanostructure may be in a form of flower-shaped nanostructures, star-shaped nanostructures, hollow structures, porous structures, nanocomposites, hybrids, toothed structures, branched structures, etc.

In a first scenario, a first mixture of exemplary self-assembled inorganic nanostructures from a plurality of inorganic nanostructures may be formed. In an exemplary embodiment, an exemplary method may include pouring an aqueous solution into a container and adding a first plurality of inorganic nanostructures with a weight ratio of 0.05:100 to 40:100 (the first plurality of inorganic nanostructures: the aqueous solution) into the container. In an exemplary embodiment, an exemplary mixture of the first plurality of inorganic nanostructures and the aqueous solution may be homogenized using a homogenizer while adding the first plurality of inorganic nanostructures to the aqueous solution. In an exemplary embodiment, the first plurality of inorganic nanostructures may include a metal, a metal oxide and a metal hydroxide, Silicon (Si), Boron (B), Silicon dioxide (SiO₂), a salt, a composite, clays, layered double hydroxides (LDHs), MXenes, magnetites, carbon nanotubes (CNTs), fullerene, graphene, graphene oxide, reduced graphene oxide, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof. An exemplary metal may include at least one of Silver (Ag), Copper (Cu), Platinum (Pt), gold (Au), Manganese (Mn), Tin (Sn), Iron (Fe), Lead (Pb), Iridium (Ir), Cobalt (Co), Tellurium (Te), Nickel (Ni), Niobium (Nb), Vanadium (V), Tungsten (W), and combinations thereof and an exemplary metal oxide and metal hydroxide may include at least one of Titanium dioxide (TiO₂), Zinc oxide (ZnO), Copper oxide (CuO), Iron oxide (Fe₂O₃), Iron oxide (Fe₃O₄), Magnesium oxide (MgO), Magnesium hydroxide (MgOH), and combinations thereof. In an exemplary embodiment, an exemplary salt may include at least one of Calcium carbonate (CaCO₃), Silicon carbide (SiC), Iron phosphorus trisulfide (FePS₃), Strontium stannate (SrSno₃), Tungsten ditelluride (WTe₂), Potassium heptafluorotantalate (K₂TaF₇), Tungsten disulfide (WS₂), Magnesium diboride (MgB₂), Niobium disulfide (NbS₂), transition metal chalcogenides (TMCs), and combinations thereof and an exemplary composite may include at least one of Silver/Zinc oxide (Ag/ZnO), Silver/Silicon dioxide (Ag/SiO₂), Silver/Titanium dioxide (Ag/TiO₂), and combinations thereof. In an exemplary embodiment, an exemplary homogenizer may include an ultrasonic probe with a power of at least 5 kJ. As used herein the ultrasonic probe may be a device with a probe that homogenizes a mixture by using an ultrasound energy to agitate the mixture. In an exemplary embodiment, an aqueous solution may include one of distilled water, deionized water, municipal water, water with total dissolved solids (TDS) of between 1 ppm and 50000 ppm, recycled water, etc., and combinations thereof.

An exemplary method may further include adding a second plurality of inorganic nanostructures into the container for at least 10 seconds; thereby, a mixture of the second plurality of inorganic nanostructures and the first plurality of inorganic nanostructures in the aqueous solution may be formed. In an exemplary embodiment, an exemplary mixture of the second plurality of inorganic nanostructures and the first plurality of inorganic nanostructures may be uniformly dispersed and homogenized within the aqueous solution using a homogenizer. In an exemplary embodiment, the second plurality of inorganic nanostructures may include a metal, a metal oxide, a metal hydroxide, Silicon (Si), Boron (B), Silicon dioxide (SiO₂), a salt, a composite, clays, layered double hydroxides (LDHs), MXenes, magnetites, carbon nanotubes (CNTs), fullerene, graphene, graphene oxide, reduced graphene oxide, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof. An exemplary metal may include one of Silver (Ag), Copper (Cu), Platinum (Pt), gold (Au), Manganese (Mn), Tin (Sn), Iron (Fe), Lead (Pb), Iridium (Ir), Cobalt (Co), Tellurium (Te), Nickel (Ni), Niobium (Nb), Vanadium (V), Tungsten (W), and combinations thereof and an exemplary metal oxide/hydroxide may include one of Titanium dioxide (TiO₂), Zinc oxide (ZnO), Copper oxide (CuO), Iron oxide (Fe₂O₃), Iron oxide (Fe₃O₄), Magnesium oxide (MgO), Magnesium hydroxide (MgOH), and combinations thereof. In an exemplary embodiment, an exemplary salt may include one of Calcium carbonate (CaCO₃), Silicon carbide (SiC), Iron phosphorus trisulfide (FePS₃), Strontium stannate (SrSno₃), Tungsten ditelluride (WTe₂), Potassium heptafluorotantalate (K₂TaF₇), Tungsten disulfide (WS₂), Magnesium diboride (MgB₂), Niobium disulfide (NbS₂), transition metal chalcogenides (TMCs), and combinations thereof and an exemplary composite may include one of Silver/Zinc oxide (Ag/ZnO), Silver/Silicon dioxide (Ag/SiO₂), Silver/Titanium dioxide (Ag/TiO₂), and combinations thereof. In an exemplary embodiment, the first plurality of inorganic nanostructures may include a first plurality of superficial sites with opposite-signed surface zeta potential respective to a surface zeta potential of a second plurality of superficial sites of the second plurality of inorganic nanostructures. In an exemplary embodiment, the first plurality of inorganic nanostructures may have a positive surface zeta potential while the second plurality of inorganic nanostructures may have a negative surface zeta potential. In another exemplary embodiment, the first plurality of inorganic nanostructures may have a negative surface zeta potential while the second plurality of inorganic nanostructures may have a positive surface zeta potential. In an exemplary embodiment, an exemplary surface zeta potential may refer to surface charge of particles dispersed in a media. In an exemplary embodiment, an exemplary opposite surface zeta potential may refer to opposite sign of surface charge of a first plurality of particles dispersed in a media respective to sign of surface charge of a second plurality of particles dispersed in an exemplary media. An opposite surface zeta potential of the first plurality of superficial sites of the first plurality of inorganic nanostructures with respect to the surface zeta potential of the second plurality of superficial sites of the second plurality of inorganic nanostructures may enhance electrostatic interactions between the first plurality of inorganic nanostructures and the second plurality of inorganic nanostructures. In an exemplary embodiment, exemplary electrostatic interactions between the first plurality of inorganic nanostructures and the second plurality of inorganic nanostructures may also ignite self-assembling of inorganic nanostructures. In an exemplary embodiment, Electrostatic interactions between the first plurality of inorganic nanostructures and the second plurality of inorganic nanostructures may lead to form a first plurality of self-assembled inorganic nanostructures as a combination of the first plurality of inorganic nanostructures and the second plurality of inorganic nanostructures within the aqueous solution.

In a second exemplary scenario, an exemplary method for forming a second plurality of self-assembled inorganic nanostructures from at least two inorganic nanostructures is described. In an exemplary embodiment, an exemplary method may include forming a first mixture of a first plurality of self-assembled inorganic nanostructures according to an exemplary first scenario. In an exemplary embodiment, to form an exemplary second plurality of self-assembled inorganic nanostructures, a second mixture may be formed. In an exemplary embodiment, to form an exemplary second mixture, a third plurality of inorganic nanostructures with a concentration of at least 5 ppm (the third plurality of inorganic nanostructures in the aqueous solution) may be added into the container. In an exemplary embodiment, an exemplary second mixture may be homogenized using a homogenizer while adding the third plurality of inorganic nanostructures to the aqueous solution with a sonication power of at least 5 kJ at a temperature of at least 2° C. In an exemplary embodiment, the third plurality of inorganic nanostructures may include a metal, a metal oxide, a metal hydroxide, Silicon (Si), Boron (B), Silicon dioxide (SiO₂) a salt, a composite, clays, layered double hydroxides (LDHs), MXenes, magnetites, graphene, graphene oxide, reduced graphene oxide, carbon nanotubes (CNTs), fullerene, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof. An exemplary metal may include at least one of Silver (Ag), Copper (Cu), Platinum (Pt), gold (Au), Manganese (Mn), Tin (Sn), Iron (Fe), Lead (Pb), Iridium (Ir), Cobalt (Co), Tellurium (Te), Nickel (Ni), Niobium (Nb), Vanadium (V), Tungsten (W), and combinations thereof and an exemplary metal oxide/hydroxide may include at least one of Titanium dioxide (TiO₂), Zinc oxide (ZnO), Copper oxide (CuO), Iron oxide (Fe₂O₃), Iron oxide (Fe₃O₄), Magnesium oxide (MgO), Magnesium hydroxide (MgOH), and combinations thereof. In an exemplary embodiment, an exemplary salt may include at least one of Calcium carbonate (CaCO₃), Silicon carbide (SiC), Iron phosphorus trisulfide (FePS₃), Strontium stannate (SrSno₃), Tungsten ditelluride (WTe₂), Potassium heptafluorotantalate (K₂TaF₇), Tungsten disulfide (WS₂), Magnesium diboride (MgB₂), Niobium disulfide (NbS₂), transition metal chalcogenides (TMCs), and combinations thereof and an exemplary composite may include at least one of Silver/Zinc oxide (Ag/ZnO), Silver/Silicon dioxide (Ag/SiO₂), Silver/Titanium dioxide (Ag/TiO₂), and combinations thereof.

In an exemplary embodiment, to form a second mixture of self-assembled inorganic nanostructures, the third plurality of inorganic nanostructures may be added into the first mixture formed via exemplary first scenario with a concentration of at least 5 ppm (the third plurality of inorganic nanostructures in the aqueous solution). In an exemplary embodiment, mixing the third plurality of inorganic nanostructures and the first mixture may help forming controlled arrangements of inorganic nanostructures, in which the controlled arrangements may be developed by electrostatic interactions. In an exemplary embodiment, exemplary electrostatic interactions may be formed between the third plurality of inorganic nanostructures, the first plurality of inorganic nanostructures and the second plurality of inorganic nanostructures due to a third plurality of superficial sites with opposite-signed surface zeta potential of the third plurality of inorganic nanostructures respective to a surface zeta potential of at least one of the first plurality of superficial sites and the second plurality of superficial sites of the formed self-assembled inorganic nanostructures. In an exemplary embodiment, each of the first plurality of inorganic nanostructures, the second plurality of inorganic nanostructures, and the third plurality of inorganic nanostructures may include nanostructures of a metal, a metal oxide, a metal hydroxide, Silicon (Si), Boron (B), Silicon dioxide (SiO₂), a salt, a composite, clays, layered double hydroxides (LDHs), MXenes, magnetites, graphene, graphene oxide, reduced graphene oxide, carbon nanotubes (CNTs), fullerene, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof, with at least one dimension with a size of less than about 100 nm.

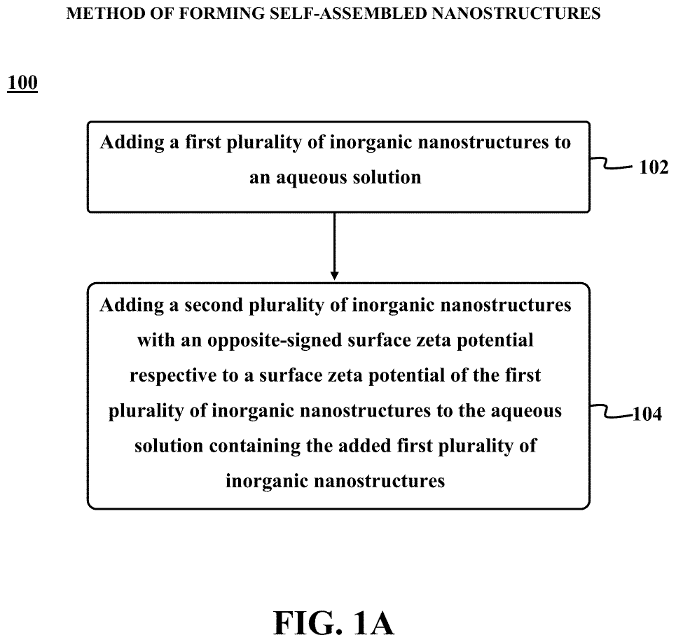

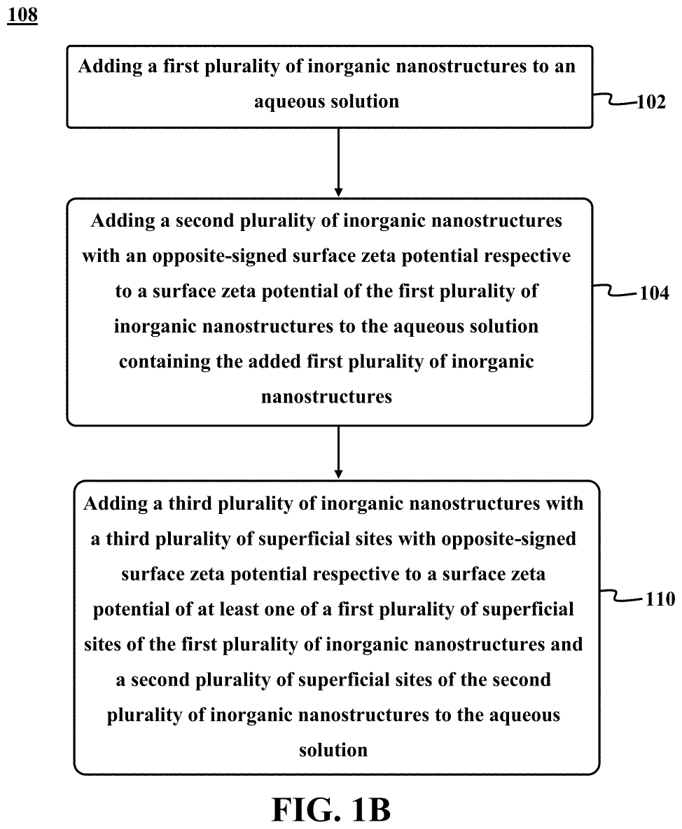

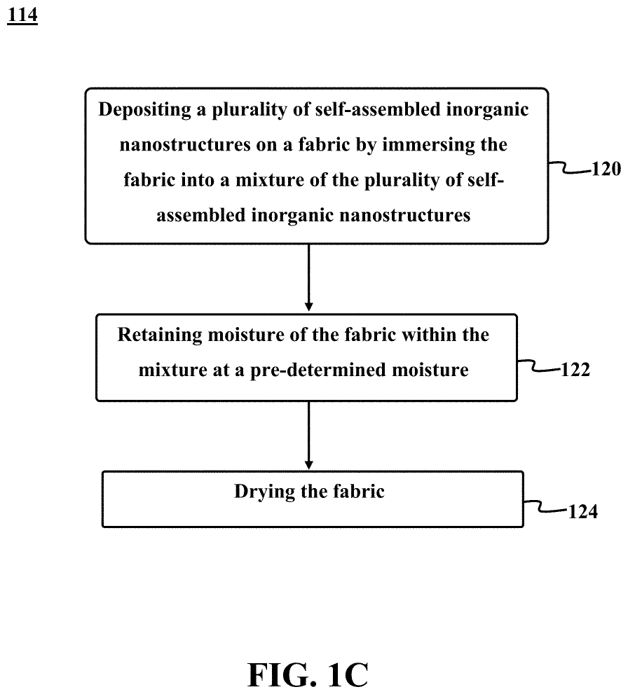

FIG. 1A shows a flowchart of a method 100 for forming self-assembled inorganic nanostructures, consistent with one or more exemplary embodiments of the present disclosure. In an exemplary embodiment, method 100 may include forming a first mixture by adding a plurality of inorganic nanostructures to an aqueous solution at a weight ratio in a range of about 0.001:100 to about 40:100 (the plurality of inorganic nanostructures: the aqueous solution). In an exemplary implementation, forming an exemplary first mixture may include a step 102 of adding a first plurality of inorganic nanostructures to an aqueous solution and a step 104 of adding a second plurality of inorganic nanostructures with an opposite-signed surface zeta potential respective to a surface zeta potential of the first plurality of inorganic nanostructures to the aqueous solution containing the added first plurality of inorganic nanostructures.

In an exemplary embodiment, step 102 of forming a first mixture by adding a first plurality of inorganic nanostructures to an aqueous solution may include pouring an exemplary aqueous solution into a container and adding an exemplary first plurality of inorganic nanostructures to an exemplary aqueous solution in an exemplary container. In an exemplary embodiment, an exemplary first plurality of inorganic nanostructures may be added to an exemplary aqueous solution with a weight ratio between 0.001:100 and 40:100 (an exemplary first plurality of inorganic nanostructures: an exemplary aqueous solution). In an exemplary embodiment, an exemplary mixture of an exemplary aqueous solution and an exemplary first plurality of inorganic nanostructures may be homogenized while adding an exemplary first plurality of inorganic nanostructures to an exemplary aqueous solution using a homogenizer. In an exemplary embodiment, an exemplary mixture of an exemplary aqueous solution and an exemplary first plurality of inorganic nanostructures may be homogenized for at least 10 seconds with a power of an exemplary homogenizer of at least 5 kJ. In an exemplary embodiment, an exemplary homogenizer may include an ultrasonic probe. As used herein, an exemplary ultrasonic probe may be a device with a probe that homogenizes a mixture using an ultrasound energy to agitate an exemplary mixture. In an exemplary embodiment, an exemplary mixture of an exemplary aqueous solution and an exemplary first plurality of inorganic nanostructures may be homogenized at a temperature of at least 2° C. In an exemplary embodiment, an exemplary temperature of an exemplary mixture of an exemplary aqueous solution and an exemplary first plurality of inorganic nanostructures may be controlled using a water bath for an exemplary container during homogenization. In an exemplary embodiment, to control an exemplary temperature, an exemplary container may be placed inside a water bath containing water with a controlled temperature of below 40° C. In an exemplary embodiment, an exemplary temperature of an exemplary mixture of an exemplary aqueous solution and an exemplary first plurality of inorganic nanostructures may be performed at a temperature without requirements to control temperature.

In an exemplary embodiment, an exemplary first plurality of inorganic nanostructures may include a metal, a metal oxide, a metal hydroxide, Silicon (Si), Boron (B), Silicon dioxide (SiO₂), a salt, a composite, clays, layered double hydroxides (LDHs), MXenes, magnetites, graphene, graphene oxide, reduced graphene oxide, carbon nanotubes (CNTs), fullerene, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof. An exemplary metal may include at least one of Silver (Ag), Copper (Cu), Platinum (Pt), gold (Au), Manganese (Mn), Tin (Sn), Iron (Fe), Lead (Pb), Iridium (Ir), Cobalt (Co), Tellurium (Te), Nickel (Ni), Niobium (Nb), Vanadium (V), Tungsten (W), and combinations thereof and an exemplary metal oxide and an exemplary metal hydroxide may include at least one of Titanium dioxide (TiO₂), Zinc oxide (ZnO), Copper oxide (CuO), Iron oxide (Fe₂O₃), Iron oxide (Fe₃O₄), Magnesium oxide (MgO), Magnesium hydroxide (MgOH), and combinations thereof. In an exemplary embodiment, an exemplary salt may include one of Calcium carbonate (CaCO₃), Silicon carbide (SiC), Iron phosphorus trisulfide (FePS₃), Strontium stannate (SrSno₃), Tungsten ditelluride (WTe₂), Potassium heptafluorotantalate (K₂TaF₇), Tungsten disulfide (WS₂), Magnesium diboride (MgB₂), Niobium disulfide (NbS₂), transition metal chalcogenides (TMCs), and combinations thereof and an exemplary composite may include at least one of Silver/Zinc oxide (Ag/ZnO), Silver/Silicon dioxide (Ag/SiO₂), Silver/Titanium dioxide (Ag/TiO₂), and combinations thereof. In an exemplary embodiment, an exemplary aqueous solution may include one of distilled water, deionized water, municipal water, water with total dissolved solids (TDS) of between 1 ppm and 50000 ppm, recycled water, etc., and combinations thereof.

In an exemplary embodiment, self-assembled inorganic nanostructures may be formed in the first mixture by adding an exemplary first plurality of inorganic nanostructures to an aqueous solution in step 102. In an exemplary embodiment, the first mixture may include a suspension or a mixture of exemplary formed self-assembled inorganic nanostructures. Exemplary formed self-assembled inorganic nanostructures may include different forms or shapes of nanostructures, such as nanoplate, nanofiber, nanotube, nanoparticle, etc. An exemplary formed self-assembled inorganic nanostructure may be in a form of flower-shaped nanostructures, star-shaped nanostructures, hollow structures, porous structures, nanocomposites, hybrids, toothed structures, branched structures, etc. In an exemplary embodiment, exemplary structures produced by an exemplary formed plurality of inorganic nanostructures may include hollow structure, porous structure, nanocomposites, hybrids, toothed structures, branched structures, etc. In an exemplary embodiment, to produce such various structures, an exemplary aqueous solution may include a pH value that an exemplary first plurality of inorganic nanostructures may include opposite-signed surface zeta potential respective a surface zeta potential of an exemplary second plurality of inorganic nanostructure at that pH value.

In an exemplary embodiment, an exemplary first plurality of inorganic nanostructures may include a first plurality of superficial sites with opposite-signed surface zeta potential respective to a surface zeta potential of a second plurality of superficial sites of an exemplary second plurality of inorganic nanostructures. In an exemplary embodiment, exemplary superficial sites may refer to superficial sites on outer surface of exemplary nanostructures, where superficial sites may have a positive surface zeta potential, a negative surface zeta potential, a neutral surface zeta potential, and combinations thereof. In an exemplary embodiment, exemplary superficial sites may include at least one of a plurality of superficial sites with positive electrostatic charges on surface of nanostructures, a plurality of superficial sites with negative electrostatic charges on surface of nanostructures, and/or combinations thereof. In an exemplary embodiment, an exemplary first plurality of inorganic nanostructures may have both superficial sites with a positive surface zeta potential and superficial sites with a negative surface zeta potential. In an exemplary embodiment, an exemplary nanostructure with both negative and positive exemplary superficial sites may include an exemplary nanostructure with opposite-signed superficial sites, for example, functionalized graphene, core shell structure of Si/Ag, etc. In an exemplary embodiment, functionalized graphene may include graphene with positive surface zeta potential and functionalized groups with negative surface zeta potential. In another exemplary embodiment, functionalized graphene may include graphene with negative surface zeta potential and functionalized groups with positive surface zeta potential. In an exemplary embodiment, an exemplary first plurality of nanostructures having exemplary superficial sites with opposite-signed surface zeta potential may form a first plurality of self-assembled inorganic nanostructures.

In another exemplary embodiment, an exemplary first plurality of inorganic nanostructures may include at least one of metals such as Silver (Ag), Copper (Cu), Platinum (Pt), Gold (Au), Manganese (Mn), Tin (Sn), Iron (Fe), Lead (Pb), Iridium (Ir), Cobalt (Co), Tellurium (Te), Nickel (Ni), Niobium (Nb), Vanadium (V), Tungsten (W), Zinc (Zn), Titanium (Ti), Silicon (Si), and Boron (B). Oxides/hydroxides of Silver (Ag), Copper (Cu), Platinum (Pt), Gold (Au), Manganese (Mn), Tin (Sn), Iron (Fe), Lead (Pb), Iridium (Ir), Cobalt (Co), Tellurium (Te), Nickel (Ni), Niobium (Nb), Vanadium (V), Tungsten (W), Zinc (Zn), Titanium (Ti), Silicon (Si), and Boron (B), a metal oxide or a metal hydroxide such as Titanium dioxide (TiO₂), Zinc oxide (ZnO), Copper oxide (CuO), Silicon dioxide (SiO₂), Iron oxide (Fe₂O₃), Iron oxide (Fe₃O₄), Magnesium oxide (MgO), and Magnesium hydroxide (MgOH), Salts of Titanium (Ti), Calcium (Ca), Sodium (Na), Tellurium (Te), Copper (Cu), Selenium (Se), Iron (Fe), Carbon (C), Zinc (Zn), Silicon (Si), Titanium (Ti), Germanium (Ge), Gallium (Ga), Cobalt (Co), Cerium (Ce), Iridium (Ir), Vanadium (V), Strontium (Sr), Tantalum (Ta), Cadmium (Cd), Manganese (Mn), Magnesium (Mg), Tin (Sn), Niobium (Nb), Antimony (Sb), Lead (Pb), Platinum (Pt), Gold (Au), Silver (Ag), Aluminum (AL), Tungsten (W), Molybdenum (Mo), Potassium (K), transition metal chalcogenides, etc., with one another and/or with Chlorine (Cl), Fluorine (F), Sulfur (S), Iodine (I), Boron (B), Nitrogen (N), Phosphorus (P), Sulfate (SO₄), Nitrate (NO₃), Carbonate (CO₃), Bicarbonate (HCO₃), Periodate (IO₄), Phosphate (PO₄), etc., and combinations thereof, multi and bimetals with one of Ti, Ca, Te, Cu, Se, Fe, C, Zn, Si, Ge, Ga, Co, Ce, Ir, Sr, Ta, V, Cd, Mn, Mg, Sn, Nb, Sb, Pb, Pt, Au, Ag, W, Te, Na, K (with a mass ratio between 1 ppm and 99.9 w/w %) and combinations thereof, Clays, LDHs, MXenes, magnetites, carbon structures (e.g. CNT, carbon nanofibres (CNFs), fullerene, graphene, graphene oxide, reduced graphene oxide (rGO), MOFs, hBN, borophene, Bismuth strontium calcium copper oxide (BSCCO), kagome lattices (e.g. kagome (BETS)₂GaCl₄), BETS metal compounds (e.g. (BETS)₂GaCl₄), hydroxyapatite, phosphosilicates, composites of SiO₂, TiO₂, MgO, MgOH, CuO, ZnO, Fe₂O₃, Fe₃O₄, Ag, Ce, Cu, Pt, Au, V, Ca, Mg, Mn, Mg, Sn, Ga, Fe, Pb, Al, Cd, Si, Co, Te, B, SrSno₃.MgB₂, WTe₂, WS₂, Ag/ZnO, Ag/SiO₂, Ag/TiO₂, NbS₂, FePS₃, clays, CaCO₃, SiC, LDH, Na₃N, MXenes, magnetites, hBN, borophene, CNFs, CNT, fullerene, carbon structures, MOFs, Ir, Mo, Ni, SiC, Sn, Pd, Nb, W, Sr, Si, Potassium heptafluorotantalate (K₂TaF₇), Bismuth strontium calcium copper oxide (BSCCO), kagome lattices, hydroxyapatite, bioglass, biomaterials, their oxygen compounds, etc., such as Ag/TiO₂, Au/SiO₂, Ag/ZnO, Ag/SiO₂, Ag/TiO₂, including core-shells, etc., (with a mass ratio between 1 ppm to 99 w/w %). Ion loaded nanostructures by Cl, F, S, Fe, I, B, N, P, Te, Cu, Se, C, Zn, Si, Ti, Ge, Ga, Co, Ce, Ir, Sr, Ta, Cd, Mn, Se, Mg, Sn, Nb, Sb, Pb, Pt, Au, Ag, W, Mo, Te, Na, K, their anionic species for example with O (e.g. Sulfate (SO₄), Nitrate (NO₃), Carbonate (CO₃), Bicarbonate (HCO₃), Periodate (IO₄), Phosphate (PO₄)), etc., with a mass ratio between 1 ppm and 80 w/w %. Nanostructures treated, activated, and/or etched via one of methods of treating, activating, coating, etching, patterning, and/or decorating using chemical methods (oxidants, acids, alkalis, organic solvents, etc.), irradiation based methods e.g. laser, plasma, gamma, rays ultraviolet (UV) electronic waves, magnetron, microwave, lithography, ion etching pretreatments, atomic force microscopy, PVD, CVD, sputtering, electrospray, etc., and combinations thereof, organic/inorganic nanostructures in which the organic component may be at least one of anhydrides (e.g. Maleic anhydride), acrylic acid, n-methylols, carbamides, acrylic resins, silicones, polysiloxanes, polyurethanes, aldehydes, PVA, PA, polyols, polyoxides, polyesters, proteins, polycarbonates, polystyrenes, polysaccharides, carbohydrates, polyelectrolytes, hydrogels, poly(sodium acrylate), polyimides, PAMAMs, polyaniline, polyvinyls, PVdF, their monomers, ammonias, dendrimers, cyclodextrin, amphiphilics, liposomes, macromolecules, superstructures, biomaterials, metamaterials, BETS, electrolytes, MOFs, drugs, dyes, softeners, antistatic, flame-retardants, etc. their derivatives, their mixtures (with a mass ratio between 0.01% and 99.5%), their co- or tri-polymers (with a weight ratio between 0.01% and 99.5%), and combinations thereof.

In an exemplary embodiment, step 104 of adding a second plurality of inorganic nanostructures to the aqueous solution containing the added first plurality of inorganic nanostructures. In an exemplary embodiment, step 104 may include adding an exemplary second plurality of inorganic nanostructures to an exemplary aqueous solution containing the added first plurality of inorganic nanostructures for at least 10 seconds; therefore, resulting in forming the first mixture. In an exemplary embodiment, to form an exemplary first mixture, an exemplary second plurality of inorganic nanostructures may be added to an exemplary mixture of an exemplary first plurality of inorganic nanostructures and an exemplary aqueous solution with a concentration in a range of 0.001:100 to 40:100 (an exemplary second plurality of inorganic nanostructure: an exemplary aqueous solution). In an exemplary embodiment, an exemplary first mixture may be homogenized for at least 10 seconds with a power of an exemplary homogenizer of at least 5 kJ. In an exemplary embodiment, an exemplary homogenizer may include an ultrasonic probe. In an exemplary embodiment, an exemplary first mixture may be homogenized at a temperature of at least 2° C.

In an exemplary embodiment, an exemplary pH of an exemplary first mixture may be controlled at a specific pH value, leading to form self-assembled inorganic nanostructures with specific shapes or structures. In an exemplary embodiment, to form self-assembled inorganic nanostructures with any shapes or structures, an exemplary aqueous solution may include a pH value so that an exemplary first plurality of inorganic nanostructures may include opposite-signed surface zeta potential respective to a surface zeta potential of an exemplary second plurality of inorganic nanostructures at that pH value. In an exemplary embodiment, an exemplary pH value may be controlled by adding a buffer solution, an acid solution, and a base solution in an exemplary mixture of an exemplary aqueous solution and an exemplary first plurality of inorganic nanostructures. In an exemplary embodiment, acidic materials, for example, citric acid, acetic acid, hydrochloric acid (HCL), perchloric acid (HCLO₄), nitric acid (HNO₃), etc., may be applied by adding the acidic material to the first mixture to adjust a range of pH below 7 for forming TiO₂-based self-assembled nanostructures. In an exemplary embodiment, bases including inorganic bases and/or organic bases (e.g. ethylenediamine) may be used to adjust a pH value of the first mixture above 7. In an exemplary embodiment, in these cases, adjusting pH value of an initial media and/or first solution including the aqueous solution after adding the first plurality of nanostructures may satisfy a desired pH condition leading to form an arbitrary structure of exemplary formed self-assembled nanostructures without need to a dynamic or step-by-step checking a pH value of the first mixture through an exemplary process of exemplary method 100. However, for sensitive systems, a value of pH may be dynamically recorded and adjusted by varying an added dosage of an acid and/or a base. In an exemplary embodiment, to adjust a pH value of the first mixture, a buffer system may be added to an exemplary aqueous solution and/or exemplary first mixture. In an exemplary embodiment, a mixture of acetic acid and sodium acetate or a buffer system based on using buffering agents such as acetic acid, citric acid, Potassium Phosphate (KH₂PO₄), N-Cyclohexyl-2-aminoethanesulfonic acid (CHES) and borates, etc. may be applied. In an exemplary embodiment, adding Disodium phosphate (Na₂HPO₄) and citric acid mixtures to an exemplary aqueous solution and/or exemplary first mixture may satisfy an adjusted pH between 3-8 (by adjusting a ratio of Na₂HPO₄ and citric acid). In an exemplary embodiment, phosphate buffered saline may be employed to set pH value of an exemplary first mixture at about 7.4, and so on. However, a self-assembling process according to exemplary method 100 for forming self-assembled nanostructures may include adding a plurality of inorganic nanostructures to pure water with a pH of about 7 or an accessible source of water without need to a primary pH adjustment and/or control pH value through an exemplary process. In an exemplary embodiment, forming self-assembled nanostructures of Ag and SiO₂ nanostructures, or Ag/SiO₂ nanostructures, or TiO₂ and Ag—SiO₂ core-shell nanostructures, or Se and Ag/SiO₂ nanostructures, or Pt/TiO₂ (e.g. needle-shape, branched, etc.), or Ag/rGO nanostructures, Ag—SiO₂ core-shell nanostructures, etc.) may be conducted by adding exemplary nanostructures to pure water with a pH around 7 or an accessible source of water without need to a primary pH adjustment and/or control pH value through an exemplary process. In an exemplary embodiment, pH ranges above or below the point of zero charges of each pair or multi exemplary plurality of nanostructures may be also considered in a case that a selective repulsive force is needed for a desired control on exemplary self-assembling processes. In an exemplary embodiment, an exemplary mixture of an exemplary aqueous solution and an exemplary first plurality of inorganic nanostructures may be formed at a pH value without controlling an exemplary pH value. In an exemplary embodiment, controlling an exemplary pH may be used when more than two plurality of superficial sites may be affected by attractive or repulsive forces to drive a selective behavior. In an exemplary embodiment, a selective attachment may be concurrently directed considering an accessibility of charged superficial sites of nanostructures, charge density, etc. In an exemplary embodiment, different structures of self-assembled inorganic nanostructures may be formed utilizing an exemplary plurality of inorganic nanostructures via exemplary method 100, for example, hollow structure, porous structure, nanocomposites, hybrids, toothed structures, branched structures, etc. may be formed.

In an exemplary embodiment, an exemplary first plurality of inorganic nanostructures may include a first plurality of superficial sites with opposite-signed surface zeta potential respective to a surface zeta potential of a second plurality of superficial sites of an exemplary second plurality of inorganic nanostructures. An exemplary opposite-signed surface zeta potential between an exemplary first plurality of inorganic nanostructures and an exemplary second plurality of inorganic nanostructures may generate an electrostatic interaction between an exemplary first plurality of inorganic nanostructures and an exemplary second plurality of inorganic nanostructures leading to form a plurality of self-assembled inorganic nanostructures. In an exemplary embodiment, an exemplary electrostatic interaction may ignite self-assembling of an exemplary first plurality of inorganic nanostructures and an exemplary second plurality of inorganic nanostructures.

In an exemplary embodiment, an exemplary pH of an exemplary first mixture of an exemplary aqueous solution containing an exemplary first plurality of inorganic nanostructures and an exemplary second plurality of inorganic nanostructures may be controlled at a specific pH value, leading to form self-assembled inorganic nanostructures with specific shapes or structures. In an exemplary embodiment, an exemplary pH value may be controlled by adding a buffer solution, an acid solution, a base solution, and combinations thereof in an exemplary first mixture. In an exemplary embodiment, at least one of citric acid, acetic acid, hydrochloric acid (HCL), Perchloric acid (HCLO₄), Nitric acid (HNO₃), etc., and combinations thereof may be applied to an exemplary first mixture to adjust a range of pH below 7 in a process of forming self-assembled TiO₂-based nanostructures. In an exemplary embodiment, inorganic bases or organic bases (e.g. ethylenediamine) may be used to adjust a pH value of an exemplary first mixture above 7. In an exemplary embodiment, adjusting pH value of an exemplary first mixture may include adjusting pH of an exemplary initial media and/or first solution (after adding the first plurality of nanostructures) may satisfy a pH condition without need to a dynamic or step-by-step check of pH value of an exemplary first mixture through an exemplary process of method 100. However, for sensitive systems, pH of an exemplary first mixture may be dynamically recorded and adjusted by dosing an exemplary required acid and/or base. Alternatively, a buffer system (e.g. acetic acid and sodium acetate mixtures, etc.) or a buffer system based on using buffering agents such as acetic acid, citric acid, Potassium Phosphate (KH₂PO₄), N-Cyclohexyl-2-aminoethanesulfonic acid (CHES) and borates, etc. may be applied to an exemplary first mixture; for instance, Disodium phosphate (Na₂HPO₄) and citric acid mixtures may satisfy an adjusted pH between 3-8 (by adjusting the ratio of Na₂HPO₄ and citric acid), phosphate buffered saline may be employed to set pH at 7.4, and so on. In an exemplary embodiment, a self-assembling process of inorganic nanostructures, such as Ag and SiO₂ nanostructures, Ag/SiO₂ nanostructures, TiO₂ and Ag—SiO₂ core-shell nanostructures, Se and Ag/SiO₂ nanostructures, Pt/TiO₂ (e.g. needle-shape, branched, etc.), Ag/rGO nanostructures, and Ag—SiO₂ core-shell nanostructures, etc. may be conducted by adding a plurality of inorganic nanostructures even in pure water with a pH around 7 or an accessible source of water without need to a primary pH adjustment and/or control through an exemplary process. In an exemplary embodiment, an exemplary first mixture may be produced at a pH value without controlling an exemplary pH. In an exemplary embodiment, controlling an exemplary pH may be used when more than two plurality of superficial sites may be affected by attractive or repulsive forces to drive a selective behavior in process of forming self-assembled inorganic nanostructures. In an exemplary embodiment, a selective attachment between superficial sites with opposite surface zeta potential may be concurrently directed considering an accessibility of charged superficial sites of nanostructures, charge density, etc. In an exemplary embodiment, to form self-assembled inorganic nanostructures with any shapes or structures, a pH value of an exemplary first mixture may include a pH value so that an exemplary first plurality of inorganic nanostructures may include opposite-signed surface zeta potential respective to a surface zeta potential of an exemplary second plurality of inorganic nanostructures at that pH value. In another exemplary embodiment, to form self-assembled inorganic nanostructures with any shapes or structures, a pH value of an exemplary first mixture may include a pH value so that an exemplary first plurality of inorganic nanostructures may include opposite-signed surface zeta potential of first plurality of superficial sites respective to a surface zeta potential of a second plurality of superficial sites of an exemplary second plurality of inorganic nanostructures. In another exemplary embodiment, to form self-assembled inorganic nanostructures with any shapes or structures, a pH value of an exemplary first mixture may include a pH value so that an exemplary first plurality of inorganic nanostructures may include a first plurality of superficial sites with opposite-signed surface zeta potential respective to a surface zeta potential of an exemplary first plurality of inorganic nanostructures.

In an exemplary embodiment, step 104 of adding a second plurality of inorganic nanostructures to the aqueous solution may further include homogenizing an exemplary first mixture formed after adding an exemplary second plurality of inorganic nanostructures to an exemplary aqueous solution containing exemplary first plurality of inorganic nanostructures. In an exemplary embodiment, an exemplary first mixture may be homogenized for at least 10 seconds with a power of an exemplary homogenizer of at least 5 kJ at a temperature of between 2° C. and 55° C. In an exemplary embodiment, an exemplary homogenizer may include an ultrasonic probe.

In another exemplary embodiment, an exemplary second plurality of inorganic nanostructures may include one of metals such as Silver (Ag), Copper (Cu), Platinum (Pt), Gold (Au), Manganese (Mn), Tin (Sn), Iron (Fe), Lead (Pb), Iridium (Ir), Cobalt (Co), Tellurium (Te), Nickel (Ni), Niobium (Nb), Vanadium (V), Tungsten (W), Zinc (Zn), Titanium (Ti), Silicon (Si), and Boron (B), oxides/hydroxides of Silver (Ag), Copper (Cu), Platinum (Pt), Gold (Au), Manganese (Mn), Tin (Sn), Iron (Fe), Lead (Pb), Iridium (Ir), Cobalt (Co), Tellurium (Te), Nickel (Ni), Niobium (Nb), Vanadium (V), Tungsten (W), Zinc (Zn), Titanium (Ti), Silicon (Si), and Boron (B), a metal oxide or a metal hydroxide such as Titanium dioxide (TiO₂), Zinc oxide (ZnO), Copper oxide (CuO), Silicon dioxide (SiO₂), Iron oxide (Fe₂O₃), Iron oxide (Fe₃O₄), Magnesium oxide (MgO), and Magnesium hydroxide (MgOH), Salts of Titanium (Ti), Calcium (Ca), Sodium (Na), Tellurium (Te), Copper (Cu), Selenium (Se), Iron (Fe), Carbon (C), Zinc (Zn), Silicon (Si), Titanium (Ti), Germanium (Ge), Gallium (Ga), Cobalt (Co), Cerium (Ce), Iridium (Ir), Vanadium (V), Strontium (Sr), Tantalum (Ta), Cadmium (Cd), Manganese (Mn), Magnesium (Mg), Tin (Sn), Niobium (Nb), Antimony (Sb), Lead (Pb), Platinum (Pt), Gold (Au), Silver (Ag), Aluminum (AL), Tungsten (W), Molybdenum (Mo), Potassium (K), transition metal chalcogenides, etc., with one another and/or with Chlorine (Cl), Fluorine (F), Sulfur (S), Iodine (I), Boron (B), Nitrogen (N), Phosphorus (P), Sulfate (SO₄), Nitrate (NO₃), Carbonate (CO₃), Bicarbonate (HCO₃), Periodate (IO₄), Phosphate (PO₄), etc., and combinations thereof, multi and bimetals with one of Ti, Ca, Te, Cu, Se, Fe, C, Zn, Si, Ge, Ga, Co, Ce, Ir, Sr, Ta, V, Cd, Mn, Mg, Sn, Nb, Sb, Pb, Pt, Au, Ag, W, Te, Na, K (with a mass ratio between 1 ppm and 99.9 w/w %) and combinations thereof, clays, LDHs, MXenes, magnetites, carbon structures (e.g. CNT, carbon nanofibres (CNFs), fullerene, graphene, graphene oxide, reduced graphene oxide (rGO), MOFs, hBN, borophene, Bismuth strontium calcium copper oxide (BSCCO), kagome lattices (e.g. kagome (BETS)₂GaCl₄), BETS metal compounds (e.g. (BETS)₂GaCl₄), hydroxyapatite, phosphosilicates, Composites of SiO₂, TiO₂, MgO, MgOH, CuO, ZnO, Fe₂O₃, Fe₃O₄, Ag, Ce, Cu, Pt, Au, V, Ca, Mg, Mn, Mg, Sn, Ga, Fe, Pb, Al, Cd, Si, Co, Te, B, SrSno₃.MgB₂, WTe₂, WS₂, Ag/ZnO, Ag/SiO₂, Ag/TiO₂, NbS₂, FePS₃, clays, CaCO₃, SiC, LDH, Na₃N, MXenes, magnetites, hBN, borophene, CNFs, CNT, fullerene, carbon structures, MOFs, Ir, Mo, Ni, SiC, Sn, Pd, Nb, W, Sr, Si, Potassium heptafluorotantalate (K₂TaF₇), Bismuth strontium calcium copper oxide (BSCCO), kagome lattices, hydroxyapatite, bioglass, biomaterials, their oxygen compounds, etc., such as Ag/TiO₂, Au/SiO₂, Ag/ZnO, Ag/SiO₂, Ag/TiO₂, including core-shells, etc. (with a mass ratio between 1 ppm to 99 w/w %). In another exemplary embodiment, an exemplary second plurality of inorganic nanostructures may include one of ion loaded nanostructures by Cl, F, S, Fe, I, B, N, P, Te, Cu, Se, C, Zn, Si, Ti, Ge, Ga, Co, Ce, Ir, Sr, Ta, Cd, Mn, Se, Mg, Sn, Nb, Sb, Pb, Pt, Au, Ag, W, Mo, Te, Na, K, their anionic species for example with O (e.g. Sulfate (SO₄), Nitrate (NO₃), Carbonate (CO₃), Bicarbonate (HCO₃), Periodate (IO₄), Phosphate (PO₄)), etc. with a mass ratio between 1 ppm and 80 w/w %. In another exemplary embodiment, an exemplary second plurality of inorganic nanostructures may include one of nanostructures that may be treated, activated, and/or etched via one of methods of treating, activating, coating, etching, patterning, and/or decorating using chemical methods (oxidants, acids, alkalis, organic solvents, etc.), irradiation based methods e.g. laser, plasma, gamma, rays ultraviolet (UV) electronic waves, magnetron, microwave, lithography, ion etching pretreatments, atomic force microscopy, physical vapor deposition (PVD), chemical vapor deposition (CVD), sputtering, electrospray, etc., and combinations thereof, organic/inorganic nanostructures in which a respective organic component may be one of anhydrides (e.g. Maleic anhydride), acrylic acid, n-methylols, carbamides, acrylic resins, silicones, polysiloxanes, polyurethanes, aldehydes, PVA, PA, polyols, polyoxides, polyesters, proteins, polycarbonates, polystyrenes, polysaccharides, carbohydrates, polyelectrolytes, hydrogels, poly(sodium acrylate), polyimides, PAMAMs, polyaniline, polyvinyls, PVdF, their monomers, ammonias, dendrimers, cyclodextrin, amphiphilics, liposomes, macromolecules, superstructures, biomaterials, metamaterials, BETS, electrolytes, MOFs, drugs, dyes, softeners, antistatic, flame-retardants, etc. and/or their derivatives, and/or their mixtures (with a mass ratio between 0.01% and 99.5%), and/or their co- or tri-polymers (with a weight ratio between 0.01% and 99.5%), and combinations thereof.

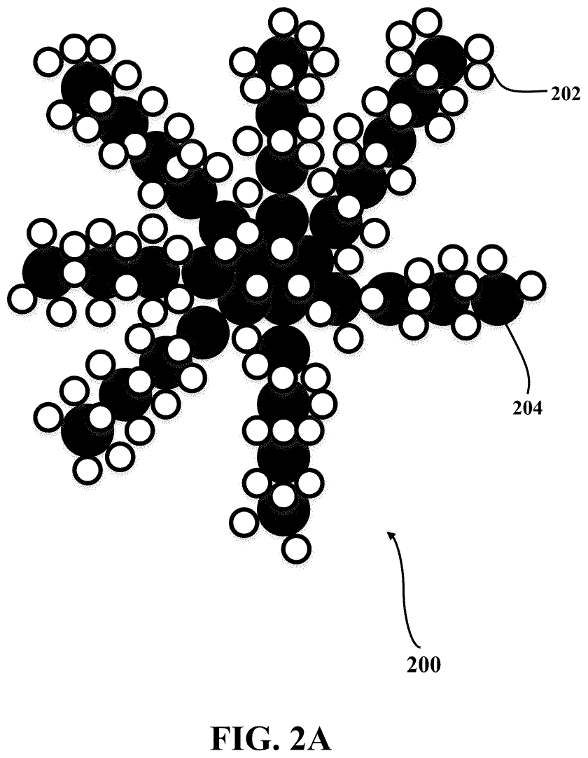

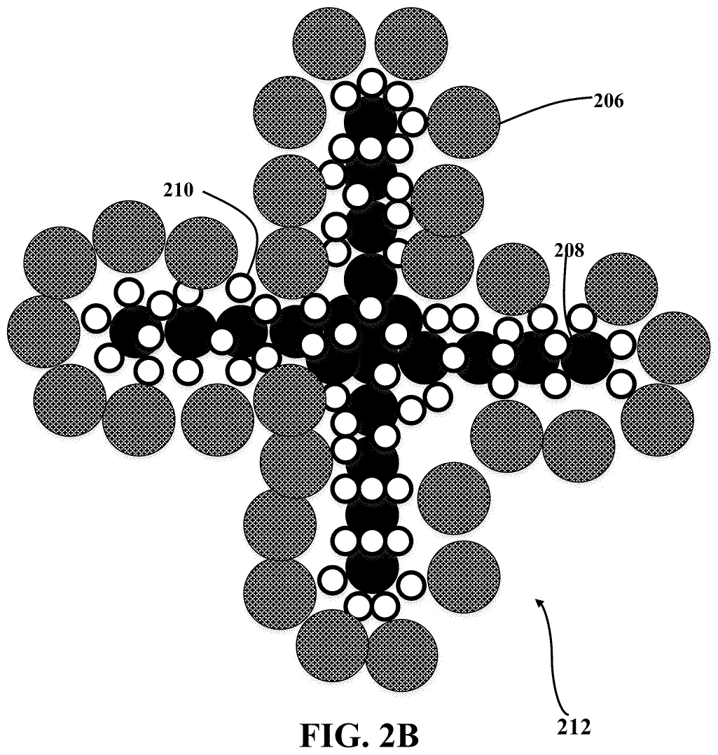

FIG. 2A shows a schematic view of exemplary flower-shaped self-assembled nanostructures 200 of an exemplary first plurality of inorganic nanostructures 204 and an exemplary second plurality of inorganic nanostructures 202 formed via an exemplary method similar to exemplary method 100, consistent with one or more exemplary embodiments of the present disclosure. In an exemplary embodiment, first plurality of inorganic nanostructures 204 may include SiO₂ nanoparticles and second plurality of inorganic nanostructures 202 may include Ag nanoparticles. In an exemplary embodiment, exemplary SiO₂ nanoparticles may be negatively charged in which exemplary Ag nanoparticles may be positively charged. In an exemplary embodiment, exemplary SiO₂ nanoparticles and exemplary Ag nanoparticles may be initially in a form of core shell structure in which exemplary Ag nanoparticles may be positioned over exemplary SiO₂ nanoparticles. In an exemplary embodiment, flower-shaped self-assembled nanostructures 200 may be produced by a method similar to method 100. In an exemplary embodiment, forming an exemplary first plurality of self-assembled inorganic nanostructures using exemplary SiO₂ nanoparticles and exemplary Ag nanoparticles may be carried out at a pH value of between 2 and 9. In an exemplary implementation of method 100, first plurality of inorganic nanostructures 204 may be added to an exemplary aqueous solution with a pH value between 2 and 9. Moreover, second plurality of nanostructures 202 may be added to a mixture of first plurality of inorganic nanostructures 204 and an exemplary aqueous solution. In another exemplary implementation of method 100, a plurality of core shell structured Ag nanoparticles positioned over exemplary SiO₂ nanoparticles may be added to an exemplary aqueous solution (not illustrated). Furthermore, a mixture of first plurality of inorganic nanostructures 204, second plurality of inorganic nanostructures 202, and an exemplary aqueous solution (not illustrated) may be homogenized for at least 10 seconds with a power of an exemplary homogenizer of at least 5 kJ; thereby, resulting in forming exemplary flower-shaped self-assembled nanostructures 200 homogenously dispersed in an exemplary formed first mixture. In an exemplary embodiment, an exemplary aqueous solution may include one of distilled water, deionized water, municipal water, water with total dissolved solids (TDS) of between 1 ppm and 50000 ppm, recycled water, etc., and combinations thereof.

In an exemplary embodiment, an exemplary first mixture may include a first plurality of self-assembled inorganic nanostructures formed via method 100. In an exemplary embodiment, an exemplary first plurality of self-assembled inorganic nanostructures may include an exemplary first plurality of inorganic nanostructures and an exemplary second plurality of inorganic nanostructures attached together and dispersed in an exemplary aqueous solution. In an exemplary embodiment, an exemplary first plurality of self-assembled inorganic nanostructures may be formed due to electrostatic interactions between an exemplary first plurality of inorganic nanostructures and an exemplary second plurality of inorganic nanostructures. In an exemplary embodiment, an exemplary first plurality of self-assembled inorganic nanostructures may be in a form of at least one of flower-shaped nanostructures, star-shaped nanostructures, hollow structures, porous structures, nanocomposites, hybrids, toothed structures, branched structures, etc.

FIG. 1B shows a flowchart of exemplary method 108 for forming self-assembled inorganic nanostructures, consistent with one or more exemplary embodiments of the present disclosure. In an exemplary embodiment, method 108 may include a step 110 of forming a second mixture by adding a third plurality of inorganic nanostructures with a third plurality of superficial sites with opposite-signed surface zeta potential respective to a surface zeta potential of at least one of the first plurality of superficial sites and the second plurality of superficial sites of a plurality of inorganic nanostructures comprising the first plurality of inorganic nanostructures and the second plurality of inorganic nanostructures to the aqueous solution, in addition to steps 102 and 104 of exemplary method 100 described hereinabove.

In an exemplary embodiment, step 110 of forming a second mixture may include adding a third plurality of inorganic nanostructures to an exemplary first mixture formed via steps 102 and 104 of exemplary method 100 described hereinabove. In an exemplary embodiment, an exemplary first mixture may include an exemplary aqueous solution containing an exemplary first plurality of inorganic nanostructures and an exemplary second plurality of inorganic nanostructures and/or the first plurality of self-assembled inorganic nanostructures formed from exemplary first plurality of inorganic nanostructures and exemplary second plurality of inorganic nanostructures. In an exemplary embodiment, step 110 may include adding an exemplary third plurality of inorganic nanostructures to an exemplary aqueous solution with a concentration of at least 5 ppm (an exemplary third plurality of inorganic nanostructures in an exemplary aqueous solution). In an exemplary embodiment, while adding an exemplary third plurality of inorganic nanostructures to an exemplary aqueous solution with a concentration of at least 5 ppm (an exemplary third plurality of inorganic nanostructures in an exemplary aqueous solution), an exemplary second mixture may be homogenized using a homogenizer. In an exemplary embodiment, an exemplary second mixture may be homogenized for at least 10 seconds with a power of an exemplary homogenizer of at least 5 kJ. In an exemplary embodiment, an exemplary homogenizer may include an ultrasonic probe. In an exemplary embodiment, an exemplary second mixture may be homogenized at a temperature of at least 2° C. In an exemplary embodiment, an exemplary temperature of an exemplary second mixture may be controlled using a water bath for an exemplary container during homogenization. In an exemplary embodiment, to control an exemplary temperature, an exemplary container may be placed inside a water bath containing water with a controlled temperature of at least 2° C. In another exemplary embodiment, an exemplary second mixture may be formed at any temperature above 2° C. with no requirements for controlling temperature. In an exemplary embodiment, a second self-assembled inorganic nanostructure may be formed due to electrostatic interactions between an exemplary first self-assembled inorganic nanostructures and an exemplary third plurality of inorganic nanostructures. In an exemplary embodiment, exemplary electrostatic interactions may be formed due to a third plurality of superficial sites of an exemplary third plurality of inorganic nanostructures with opposite-signed surface zeta potential respective to a surface zeta potential of at least one of the first plurality of superficial sites of the first plurality of inorganic nanostructures, the second plurality of superficial sites of the second plurality of inorganic nanostructures, a plurality of superficial sites of the first self-assembled inorganic nanostructures, and combinations thereof.

In an exemplary embodiment, as used herein, exemplary superficial sites may refer to sites on surface of exemplary nanostructures that may be electrostatically charged positively, negatively, and/or combinations thereof. In an exemplary embodiment, exemplary superficial sites may have a positive surface zeta potential, a negative surface zeta potential, and combinations thereof. In an exemplary embodiment, an exemplary nanostructure with exemplary superficial sites may include nanostructures with both positive and negative superficial sites thereon, for example, functionalized graphene, core shell structure of Si/Ag, etc. In an exemplary embodiment, functionalized graphene may include graphene with positive surface zeta potential and functionalized groups with negative surface zeta potential. In another exemplary embodiment, functionalized graphene may include graphene with negative surface zeta potential and functionalized groups with positive surface zeta potential. In an exemplary embodiment, the third plurality of inorganic nanostructures may include an exemplary plurality of nanostructures with both positive and negative charges thereon having exemplary superficial sites with opposite-signed surface zeta potential thereon.

In an exemplary embodiment, an exemplary third plurality of inorganic nanostructure may include a metal, a metal oxide and a metal hydroxide, Silicon (Si), Boron (B), Silicon dioxide (SiO₂), a salt, a composite, clays, layered double hydroxides (LDHs), MXenes, magnetites, carbon nanotubes (CNTs), fullerene, graphene, graphene oxide, reduced graphene oxide, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof. An exemplary metal may include one of Silver (Ag), Copper (Cu), Platinum (Pt), gold (Au), Manganese (Mn), Tin (Sn), Iron (Fe), Lead (Pb), Iridium (Ir), Cobalt (Co), Tellurium (Te), Nickel (Ni), Niobium (Nb), Vanadium (V), Tungsten (W), and combinations thereof and an exemplary metal oxide and metal hydroxide may include one of Titanium dioxide (TiO₂), Zinc oxide (ZnO), Copper oxide (CuO), Iron oxide (Fe₂O₃), Iron oxide (Fe₃O₄), Magnesium oxide (MgO), Magnesium hydroxide (MgOH), and combinations thereof. In an exemplary embodiment, an exemplary salt may include one of Calcium carbonate (CaCO₃), Silicon carbide (SiC), Iron phosphorus trisulfide (FePS₃), Strontium stannate (SrSno₃), Tungsten ditelluride (WTe₂), Potassium heptafluorotantalate (K₂TaF₇), Tungsten disulfide (WS₂), Magnesium diboride (MgB₂), Niobium disulfide (NbS₂), transition metal chalcogenides (TMCs), and combinations thereof and an exemplary composite may include one of Silver/Zinc oxide (Ag/ZnO), Silver/Silicon dioxide (Ag/SiO₂), Silver/Titanium dioxide (Ag/TiO₂), and combinations thereof.

In an exemplary embodiment, an exemplary pH of an exemplary second mixture may be controlled at a pre-determined pH value to produce self-assembled inorganic nanostructures with a desired structure, for example, forming flower-shaped and star-shaped nanostructures. In an exemplary embodiment, an exemplary pH of an exemplary second mixture may be controlled between 5 and 9 to produce flower-shaped Ag/TiO₂ of self-assembled inorganic nanostructures and/or star-shaped self-assembled inorganic nanostructures of TiO₂/Ag/SiO₂, TiO₂/Ag/TiO₂, etc. in water. In an exemplary embodiment, an exemplary pH value of an exemplary second mixture may be controlled by adding at least one buffer solution, an acid solution, a base solution, and combinations thereof in an exemplary second mixture. In an exemplary embodiment, for example, citric acid, acetic acid, hydrochloric acid (HCL), Perchloric acid (HCLO₄), Nitric acid (HNO₃), etc., may be applied to adjust a range of pH below 7 for forming self-assembled TiO₂-based nanostructures. In an exemplary embodiment, inorganic bases and/or organic bases (e.g. ethylenediamine) may be used to adjust a pH of exemplary second mixture above 7. In an exemplary embodiment, in these cases, adjusting the pH of the second mixture (after adding the third plurality of nanostructures) may satisfy the condition without need to a dynamic or step-by-step check through an exemplary process of exemplary method 108. However, for sensitive systems, pH value of exemplary second mixture may be dynamically recorded and adjusted by dosing an exemplary required acid and/or base. Alternatively, a buffer system (e.g. acetic acid and sodium acetate mixtures, etc. or a buffer system based on using buffering agents such as acetic acid, citric acid, Potassium Phosphate (KH₂PO₄), N-Cyclohexyl-2-aminoethanesulfonic acid (CHES) and borates, etc.) may be applied; for instance, Disodium phosphate (Na₂HPO₄) and citric acid mixtures may satisfy an adjusted pH between 3-8 (by adjusting the ratio of Na₂HPO₄ and citric acid), phosphate buffered saline may be employed to set pH at 7.4, and so on. However, in some exemplary cases, for example, a self-assembling process of Ag and SiO₂ nanostructures, Ag/SiO₂ nanostructures, TiO₂ and Ag—SiO₂ core-shell nanostructures, Se and Ag/SiO₂ nanostructures, Pt/TiO₂ (e.g. needle-shape, branched, etc.) and Ag/rGO nanostructures, Ag—SiO₂ core-shell nanostructures, etc., self-assembling process may be followed by adding exemplary first, second, and/or third plurality of nanostructures even in pure water with a pH around 7, or an accessible source of water without need to a primary pH adjustment and/or control through exemplary process. In an exemplary embodiment, an exemplary second mixture may be produced at a pH value without controlling an exemplary pH. In an exemplary embodiment, controlling an exemplary pH may be used when more than two plurality of superficial sites may be affected by attractive or repulsive forces to drive a selective behavior. In an exemplary embodiment, a selective attachment may be concurrently directed considering accessibility of charged superficial sites of nanostructures, charge density, etc. In an exemplary embodiment, an exemplary formed self-assembled inorganic nanostructure may also include structures with one dimension less than 10 nm (quantum size) and also structures with one dimension of more than 1 micro meter.

In an exemplary embodiment, step 110 of forming the second mixture may further include homogenizing an exemplary second mixture after adding an exemplary third plurality of inorganic nanostructures to at least one of an exemplary first mixture and an exemplary second mixture. In an exemplary embodiment, an exemplary second mixture may be homogenized for at least 10 seconds with a power of an exemplary homogenizer of at least 5 kJ. In an exemplary embodiment, an exemplary homogenizer may include an ultrasonic probe. In an exemplary embodiment, an exemplary second mixture may be homogenized at a temperature of between 2° C. and 55° C. In an exemplary embodiment, forming self-assembled inorganic nanostructures may continue by adding more inorganic nanostructures according to method 100 and method 108 by repeating one or more steps of steps 102-110 subsequently. In another exemplary embodiment, step 110 may include forming a third mixture by adding an exemplary third plurality of inorganic nanostructure to an aqueous solution in a second container and then adding the third mixture into an exemplary first mixture to form the second mixture, resulting in forming an aqueous solution of the second self-assembled inorganic nanostructures.

In an exemplary embodiment, an exemplary third plurality of inorganic nanostructure may include one of metals such as Silver (Ag), Copper (Cu), Platinum (Pt), Gold (Au), Manganese (Mn), Tin (Sn), Iron (Fe), Lead (Pb), Iridium (Ir), Cobalt (Co), Tellurium (Te), Nickel (Ni), Niobium (Nb), Vanadium (V), Tungsten (W), Zinc (Zn), Titanium (Ti), Silicon (Si), and Boron (B), oxides/hydroxides of Silver (Ag), Copper (Cu), Platinum (Pt), Gold (Au), Manganese (Mn), Tin (Sn), Iron (Fe), Lead (Pb), Iridium (Ir), Cobalt (Co), Tellurium (Te), Nickel (Ni), Niobium (Nb), Vanadium (V), Tungsten (W), Zinc (Zn), Titanium (Ti), Silicon (Si), and Boron (B), a metal oxide or a metal hydroxide such as Titanium dioxide (TiO₂), Zinc oxide (ZnO), Copper oxide (CuO), Silicon dioxide (SiO₂), Iron oxide (Fe₂O₃), Iron oxide (Fe₃O₄), Magnesium oxide (MgO), and Magnesium hydroxide (MgOH), salts of Titanium (Ti), Calcium (Ca), Sodium (Na), Tellurium (Te), Copper (Cu), Selenium (Se), Iron (Fe), Carbon (C), Zinc (Zn), Silicon (Si), Titanium (Ti), Germanium (Ge), Gallium (Ga), Cobalt (Co), Cerium (Ce), Iridium (Ir), Vanadium (V), Strontium (Sr), Tantalum (Ta), Cadmium (Cd), Manganese (Mn), Magnesium (Mg), Tin (Sn), Niobium (Nb), Antimony (Sb), Lead (Pb), Platinum (Pt), Gold (Au), Silver (Ag), Aluminum (AL), Tungsten (W), Molybdenum (Mo), Potassium (K), transition metal chalcogenides, etc., with one another and/or with Chlorine (Cl), Fluorine (F), Sulfur (S), Iodine (I), Boron (B), Nitrogen (N), Phosphorus (P), Sulfate (SO₄), Nitrate (NO₃), Carbonate (CO₃), Bicarbonate (HCO₃), Periodate (IO₄), Phosphate (PO₄), etc., and combinations thereof, multi and bimetals with one of Ti, Ca, Te, Cu, Se, Fe, C, Zn, Si, Ge, Ga, Co, Ce, Ir, Sr, Ta, V, Cd, Mn, Mg, Sn, Nb, Sb, Pb, Pt, Au, Ag, W, Te, Na, K (with a mass ratio between 1 ppm and 99.9 w/w %) and combinations thereof, clays, LDHs, MXenes, magnetites, carbon structures (e.g. CNT, carbon nanofibres (CNFs), fullerene, graphene, graphene oxide, reduced graphene oxide (rGO), MOFs, hBN, borophene, Bismuth strontium calcium copper oxide (BSCCO), kagome lattices (e.g. kagome (BETS)₂GaCl₄), BETS metal compounds (e.g. (BETS)₂GaCl₄), hydroxyapatite, phosphosilicates, Composites of SiO₂, TiO₂, MgO, MgOH, CuO, ZnO, Fe₂O₃, Fe₃O₄, Ag, Ce, Cu, Pt, Au, V, Ca, Mg, Mn, Mg, Sn, Ga, Fe, Pb, Al, Cd, Si, Co, Te, B, SrSno₃.MgB₂, WTe₂, WS₂, Ag/ZnO, Ag/SiO₂, Ag/TiO₂, NbS₂, FePS₃, clays, CaCO₃, SiC, LDH, Na₃N, MXenes, magnetites, hBN, borophene, CNFs, CNT, fullerene, carbon structures, MOFs, Ir, Mo, Ni, SiC, Sn, Pd, Nb, W, Sr, Si, Potassium heptafluorotantalate (K₂TaF₇), Bismuth strontium calcium copper oxide (BSCCO), kagome lattices, hydroxyapatite, bioglass, biomaterials, their oxygen compounds, etc., such as Ag/TiO₂, Au/SiO₂, Ag/ZnO, Ag/SiO₂, Ag/TiO₂, including core-shells, etc., (with a mass ratio between 1 ppm to 99 w/w %). In an exemplary embodiment, an exemplary third plurality of inorganic nanostructure may include one of ion loaded nanostructures by Cl, F, S, Fe, I, B, N, P, Te, Cu, Se, C, Zn, Si, Ti, Ge, Ga, Co, Ce, Ir, Sr, Ta, Cd, Mn, Se, Mg, Sn, Nb, Sb, Pb, Pt, Au, Ag, W, Mo, Te, Na, K, their anionic species for example with O (e.g. Sulfate (SO₄), Nitrate (NO₃), Carbonate (CO₃), Bicarbonate (HCO₃), Periodate (IN, Phosphate (PO₄)), etc., with a mass ratio between 1 ppm and 80 w/w %. In an exemplary embodiment, an exemplary third plurality of inorganic nanostructure may include one of nanostructures treated, activated, and/or etched via one of methods of treating, activating, coating, etching, patterning, and/or decorating using chemical methods (oxidants, acids, alkalis, organic solvents, etc.), irradiation based methods e.g. laser, plasma, gamma, rays ultraviolet (UV) electronic waves, magnetron, microwave, lithography, ion etching pretreatments, atomic force microscopy, PVD, CVD, sputtering, electrospray, etc., and combinations thereof, organic/inorganic nanostructures in which the organic component may be one of anhydrides (e.g. Maleic anhydride), acrylic acid, n-methylols, carbamides, acrylic resins, silicones, polysiloxanes, polyurethanes, aldehydes, PVA, PA, polyols, polyoxides, polyesters, proteins, polycarbonates, polystyrenes, polysaccharides, carbohydrates, polyelectrolytes, hydrogels, poly(sodium acrylate), polyimides, PAMAMs, polyaniline, polyvinyls, PVdF, their monomers, ammonias, dendrimers, cyclodextrin, amphiphilics, liposomes, macromolecules, superstructures, biomaterials, metamaterials, BETS, electrolytes, MOFs, drugs, dyes, softeners, antistatic, flame-retardants, etc. their derivatives, their mixtures (with a mass ratio between 0.01% and 99.5%), their co- or tri-polymers (with a weight ratio between 0.01% and 99.5%), and combinations thereof.

FIG. 2B shows a schematic view of exemplary star-shaped TiO₂/Ag/SiO₂ self-assembled nanostructures 212 formed via an exemplary method similar to exemplary method 108, consistent with one or more exemplary embodiments of the present disclosure. Exemplary star-shaped self-assembled nanostructures 212 may include a first plurality of inorganic nanostructures 208 such as SiO₂ nanoparticles, a second plurality of inorganic nanostructures 210 such as Ag nanoparticles, and a third plurality of inorganic nanostructures 206 such as TiO₂ nanoparticles self-assembled to each other via exemplary method 108. In an exemplary embodiment, first plurality of inorganic nanostructures 208 may be similar to first plurality of inorganic nanostructures 204. In an exemplary embodiment, second plurality of inorganic nanostructures 210 may be similar to second plurality of inorganic nanostructures 202.

In another aspect of the present disclosure, a method for nanofunctionalizing a fabric with inorganic nanostructures is disclosed. FIG. 1C shows a flowchart of an exemplary method 114 for nanofunctionalizing a fabric with self-assembled inorganic nanostructures, consistent with one or more exemplary embodiments of the present disclosure. In an exemplary embodiment, method 114 may include a step 120 of depositing a plurality of self-assembled inorganic nanostructures on a fabric by immersing the fabric into a mixture of the plurality of self-assembled inorganic nanostructures, a step 122 of retaining moisture of the fabric within the mixture at a pre-determined moisture, and a step 124 of drying the fabric.

In an exemplary embodiment, step 120 of depositing the plurality of self-assembled inorganic nanostructures on a fabric may include immersing an exemplary fabric into an exemplary mixture of an exemplary plurality of self-assembled inorganic nanostructures for at least 3 seconds. In an exemplary embodiment, immersing a fabric in a liquid may refer to dipping or submerging a fabric in a liquid. In an exemplary embodiment, an exemplary plurality of self-assembled inorganic nanostructures may include at least one of an exemplary first plurality of self-assembled inorganic nanostructures produced via method 100, an exemplary second plurality of self-assembled inorganic nanostructures produced via method 108, and combinations thereof. In an exemplary embodiment, immersing an exemplary fabric into an exemplary mixture of an exemplary plurality of self-assembled inorganic nanostructures may be performed at a temperature of 2° C. to 55° C. In an exemplary embodiment, an exemplary plurality of self-assembled inorganic nanostructures may be deposited on an exemplary fabric when immersing an exemplary fabric into an exemplary mixture of a plurality of self-assembled inorganic nanostructures. In another exemplary embodiment, an exemplary plurality of self-assembled inorganic nanostructures may be deposited on an exemplary fabric by separated or integrated processes of spraying, exhaustion, coating, dipping, impregnation, blade casting, knife casting, roll coating, padding, electrospray, sputtering, and combinations thereof.

In an exemplary embodiment, an exemplary mixture of an exemplary plurality of self-assembled inorganic nanostructures may be produced using a pure water media with a pH value around 7 according to exemplary methods 100 and/or 108 described hereinabove. In an exemplary embodiment, exemplary self-assembled nanostructures may be produced at a pH value in ranges of zero zeta potential values of two superficial sites of an exemplary plurality of inorganic nanostructures utilized for forming exemplary self-assembled nanostructures via each of methods 100 and/or 108. In an exemplary embodiment, pH values ranges above or below the zero zeta potential of each pair or multi inorganic nanostructures may be also considered in a case that a selective repulsive force may be needed for a desired control on an exemplary self-assembling process. In an exemplary embodiment, controlling an exemplary pH may be used when more than two plurality of superficial sites may be affected by attractive or repulsive forces.

In an exemplary embodiment, an exemplary mixture of the plurality of self-assembled inorganic nanostructures may include a plurality of inorganic nanostructures. In an exemplary embodiment, an exemplary plurality of inorganic nanostructure may include a metal, a metal oxide and a metal hydroxide, Silicon (Si), Boron (B), Silicon dioxide (SiO₂), a salt, a composite, clays, layered double hydroxides (LDHs), MXenes, magnetites, carbon nanotubes (CNTs), fullerene, graphene, graphene oxide, reduced graphene oxide, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof. An exemplary metal may include one of Silver (Ag), Copper (Cu), Platinum (Pt), gold (Au), Manganese (Mn), Tin (Sn), Iron (Fe), Lead (Pb), Iridium (Ir), Cobalt (Co), Tellurium (Te), Nickel (Ni), Niobium (Nb), Vanadium (V), Tungsten (W), and combinations thereof and an exemplary metal oxide and metal hydroxide may include one of Titanium dioxide (TiO₂), Zinc oxide (ZnO), Copper oxide (CuO), Iron oxide (Fe₂O₃), Iron oxide (Fe₃O₄), Magnesium oxide (MgO), Magnesium hydroxide (MgOH), and combinations thereof. In an exemplary embodiment, an exemplary salt may include one of Calcium carbonate (CaCO₃), Silicon carbide (SiC), Iron phosphorus trisulfide (FePS₃), Strontium stannate (SrSno₃), Tungsten ditelluride (WTe₂), Potassium heptafluorotantalate (K₂TaF₇), Tungsten disulfide (WS₂), Magnesium diboride (MgB₂), Niobium disulfide (NbS₂), transition metal chalcogenides (TMCs), and combinations thereof and an exemplary composite may include one of Silver/Zinc oxide (Ag/ZnO), Silver/Silicon dioxide (Ag/SiO₂), Silver/Titanium dioxide (Ag/TiO₂), and combinations thereof. In an exemplary embodiment, an exemplary mixture of the plurality of self-assembled inorganic nanostructures with a concentration in a range of 0.001 w/w % to 40 w/w % (an exemplary plurality of self-assembled inorganic nanostructures/an exemplary aqueous solution) may be used for depositing the plurality of self-assembled inorganic nanostructures on a fabric.

In an exemplary embodiment, an exemplary fabric may be a natural fabric, a synthetic fabric, a regenerated fabric, a blend and combinations thereof. In an exemplary embodiment, an exemplary natural fabric may include cotton, silk, wool, jute, linen, and combinations thereof. In an exemplary embodiment, an exemplary synthetic fabric may include polyesters such as polyethylene terephthalate (PET), polyamides such as nylon, polyimides, acrylics, polyolefins (e.g. polypropylene, polyethylene), glass, polyurethanes, carbon, optical fibers, nanofibers, etc. In an exemplary embodiment, an exemplary regenerated fabric may include viscose, casein, bamboo, etc. In an exemplary embodiment, an exemplary fabric may contain 0.001 w/w % to 300 w/w % nanostructures (an exemplary plurality of inorganic nanostructures/an exemplary fabric). In an exemplary embodiment, an exemplary plurality of self-assembled inorganic nanostructures may be deposited on one of a fabric, textile, plastic, glass, ceramic, metal, wood, paper, bill, polymer, rubber, hybrid, composite, blend, etc. and combinations thereof.

In an exemplary embodiment, step 122 of retaining moisture of the fabric may include controlling moisture of an exemplary fabric after immersing an exemplary fabric into an exemplary mixture of self-assembled inorganic nanostructures. In an exemplary embodiment, retaining may refer to maintaining or keeping. In an exemplary embodiment, retaining moisture may refer to maintaining or keeping a certain amount of moisture within the fabric. In an exemplary embodiment, retaining the moisture of the fabric may include padding the fabric after immersing the fabric into exemplary mixture of self-assembled inorganic nanostructures utilizing a padding machine. As used herein, an exemplary padding machine may be a rolling machine with exemplary rolls that may control moisture content in fabrics by changing pressure between exemplary rolls. In an exemplary embodiment, an exemplary fabric may move through exemplary rolls. In an exemplary embodiment, an exemplary padding process may be performed so that a moisture of the fabric may be retained at a predetermined moisture or wet-pick-up percent of between 10% and 120%. As used herein, an exemplary percent of a fabric wet-pick-up may refer to weight percent ratio of a solution to the fabric, where the fabric contains or is soaked in the solution. In an exemplary embodiment, wet-pick-up percent of a fabric may refer to wet-pick-up percent of the fabric after padding the fabric using a padding machine. In an exemplary embodiment, wet-pick-up percent may be determined as a controllable parameter of a padding machine for padding a fabric. In an exemplary embodiment, wet-pick-up of 50% may refer to a fabric containing a padding solution after padding process in which the padded fabric may be 1.5 times heavier than a dried fabric. In an exemplary embodiment, an exemplary fabric with a wet-pick-up of 120% may be 2.2 times heavier than the dried fabric. In an exemplary embodiment, padding an exemplary fabric may be performed at a temperature of 2° C. to 55° C. In another exemplary embodiment, an exemplary fabric treatment may be performed at least via one of methods of surface treatments including separated or integrated processes of spraying, exhaustion, coating, dipping, impregnation, blade casting, knife casting, roll coating, padding, electrospray irradiation, immersing using a coating method, etc.

In an exemplary embodiment, step 124 of drying the fabric may include heating an exemplary fabric functionalized with self-assembled inorganic nanostructures using a heater for at least 30 seconds. In an exemplary embodiment, drying may refer to dehydrating a material, such as an exemplary fabric. In an exemplary embodiment an exemplary heater may include a stenter, an oven, IR radiation, UV radiation, and combinations thereof. In an exemplary embodiments, an exemplary fabric may be heated at a temperature of between 20° C. and 200° C. In an exemplary embodiment, when using for example, carbon fabrics there may be no limitations for an exemplary temperature of an exemplary heating or drying process.

In an exemplary embodiment, exemplary method 114 of nanofunctionalizing a fabric with self-assembled inorganic nanostructures may further include coating an exemplary nanofunctionalized fabric via steps 120, 122, and 124 with a resin. In an exemplary embodiment, coating an exemplary nanofunctionalized fabric with a resin may include depositing a resin on an exemplary nanofunctionalized fabric by immersing an exemplary nanofunctionalized fabric inside a resin. In an exemplary embodiment, an exemplary nanofunctionalized fabric may be coated with an exemplary resin by one of methods of surface treatments including separated or integrated process of spraying, exhaustion, coating, dipping, impregnation, blade casting, knife casting, roll coating, padding, electrospray, sputtering, immersing, and combinations thereof. In an exemplary embodiment, it may be more common to use spraying and immersing for coating an exemplary nanofunctionalized fabric. In an exemplary embodiment, an exemplary fabric may be immersed inside an exemplary resin for at least 1 seconds. In an exemplary embodiment, an exemplary resin may include a weight ratio in a range of 0.03 w/w % to 50 w/w % (an exemplary resin/an exemplary fabric). In an exemplary embodiment, immersing an exemplary fabric inside an exemplary resin may be performed at predetermined conditions. In an exemplary embodiment, predetermined conditions may include atmospheric pressure and a temperature of 2° C. to 55° C. In an exemplary embodiment, coating an exemplary nanofunctionalized fabric with a resin may further include retaining a resin content on an exemplary nanofunctionalized fabric with a pre-determined wet-pick-up percent. In an exemplary embodiment, resin content of an exemplary nanofunctionalized fabric may be controlled using a padding machine with a wet-pick-up percent of 10% to 300%. In an exemplary embodiment, an exemplary preferred wet-pick-up percent of an exemplary nanofunctionalized fabric using a padding machine may be between 50% and 120%. In an exemplary embodiment, coating an exemplary nanofunctionalized fabric with a resin may further include drying an exemplary nanofunctionalized fabric coated with a resin. In an exemplary embodiment an exemplary nanofunctionalized fabric coated with a resin may be heated in an exemplary heater at a temperature of 20° C. to 200° C. for at least 30 seconds. In an exemplary embodiment, an exemplary heater may include one of a stenter, an oven, etc., and combinations thereof. In an exemplary embodiment, an exemplary resin may include at least one of acrylic resins, silicones, polysiloxanes, polyurethane, poly(vinyl alcohol) (PVA), polyvinylpyrrolidone (PVP), polyamide (PA), polyethylene oxide (PEO), polyols, n-methylols, polyesters, protein compounds, polysaccharides, carbohydrates, polyelectrolytes, hydrogels, poly(sodium acrylate), polyimide, poly(amidoamine) (PAMAMs), polyaniline, and polyvinylidene fluoride (PVdF). In an exemplary embodiment, an exemplary resin may also include softeners, including copolymers, functionalized, hybrid, amphiphilics in-situ synthesized ones, mixtures, composites, reinforced enriched reactants ones, reactive resins, curable, self-crosslinkable, predetermined self-crosslinkable, self-healing, subsequently-treated, and simultaneously treated ones, dendrimers, capsules, cyclodextrin, liposomes, macromolecules, superstructures, frameworks, MOFs, ions, molecules, salts, surfactants, electrolytes, drugs, dyes, antistatic, flame-retardants, anti-crease agents, nanostructures, etc., their derivatives, functionalized compositions, and/or combinations thereof. In another exemplary embodiment, an exemplary resin may include carbohydrates, polyelectrolytes, hydrogels, poly(sodium acrylate), polyimides, polyaniline, polyvinyls, their monomers, ammonias, dendrimers, cyclodextrin, amphiphilics, liposomes, macromolecules, superstructures, biomaterials, metamaterials, BETS, electrolytes, MOFs, drugs, dyes, softeners, antistatic, flame-retardants, etc. their derivatives, their mixtures (with a mass ratio between 0.01% and 99.5%), their co- or tri-polymers (with a weight ratio between 0.01% and 99.5%), and combinations thereof.

In an exemplary embodiment, coating an exemplary fabric with an exemplary resin may fix exemplary self-assembled nanostructures deposited on an exemplary fabric. In an exemplary embodiment, coating an exemplary nanofunctionalized fabric with an exemplary resin may also enhance flexibility, air permeability, stability of an exemplary fabric after washing processes, softness (handle), comfort, dimensional stability, flame-retardancy, anti-pilling, anti-crease, self-healing, controlled wetting and/or drying behavior, bioactivity, photocatalytic properties, blood and stain repellency, soil release even in an intelligent behavior and also stability of an exemplary fabric to washing, laundering, dry cleaning, abrasion, optical, chemical, mechanical, and biological thermal destructive or damaging conditions. In an exemplary embodiment, coating an exemplary resin over an exemplary self-assembled inorganic nanostructures may also protect the fabrics from the leaching out an exemplary self-assembled inorganic nanostructures from an exemplary fabric and also may protect direct contact of a skin with self-assembled inorganic nanostructures. In an exemplary embodiment, an exemplary nanofunctionalized fabric coated with an exemplary resin may be used for some especial demands, such as intelligent anti-adhesive blood coagulating membranes, high-lifetime cooling feature for summer textiles, etc. In an exemplary embodiment, an exemplary resin may be a self-networking resin at the predetermined conditions for a low-temperature or an ultra-fast process. In another exemplary embodiment, exemplary self-assembled inorganic nanostructures may be loaded on biomaterials in which exemplary biomaterials may be sensitive to high temperatures. In an exemplary embodiment, exemplary biomaterials may include proteins, vitamins, drugs, etc. In an exemplary embodiment, coating an exemplary resin may also be performed by spraying exemplary resins and/or a mixture of resin and self-assembled inorganic nanostructure. In an exemplary embodiment, the spray rate may be set to reach 10% to 200% wet-pick-up based on the dry fabric. In an exemplary embodiment, an exemplary resin and/or a resin mixtures may be coated on a nanofunctionalized fabric or a fabric by spraying for at least 0.2 s. In an exemplary embodiment, an exemplary resin may be a resin solution with a concentration of 0003:1 to 2:1 (an exemplary resin: an exemplary solvent). In an exemplary embodiment, an exemplary solvent may include one of isopropyl alcohol, methyl isobutyl ketone, dimethyl adipate, ethanol, water, etc., and combinations thereof. In an exemplary embodiment, an exemplary treated fabric may be subjected to any post treatments e.g. dying, printing, pressing, future functionalization, etching, irradiation (e.g. plasma, UV, microwave, etc.), and/or combinations thereof. In another exemplary embodiment, an exemplary nanofunctionalized fabric may be coated by one of biomaterials, metals, carbohydrate, polymers, proteins, carbon, cyclodextrin, liposomes, metal-organic frameworks (MOFs), etc. or be used as template or substrate to growth structures including one of multiple size, nano, meso or quantum size patterns, redundant structures, etc. In an exemplary embodiment, the produced self-assembled inorganic nanostructures may be subjected to any post treatments e.g. drying, printing, pressing, washing, grinding, milling, purification, future functionalization, etching, irradiation (e.g. plasma, UV, microwave, etc.), etc. In an exemplary embodiment, the produced self-assembled nanostructures may be loaded by drugs, vitamins, dyes, etc. In an exemplary embodiment, the produced self-assembled inorganic nanostructures according to this disclosure may be used for a bulk nano-functionalization simply by adding and homogenizing them into the precursor of the materials including one of polymer, glass, paper, ceramic, metal, hybrids, composites, other nanostructured materials in one of the steps of its processing including one of powder, melt, paste, solution, emulsion, colloids, sol, gel with a weight ratio of between 0.001:100 to 50:100 (the produced self-assembled nanostructures:matrix) at the process temperature (the maximum temperature may limited to the melting point of the nanostructures). In an exemplary embodiment in the case of a water-based colloidal form a temperature of above 1° C. may be considered.

### Example 1: Synthesizing Flower-Shaped Ag/SiO₂

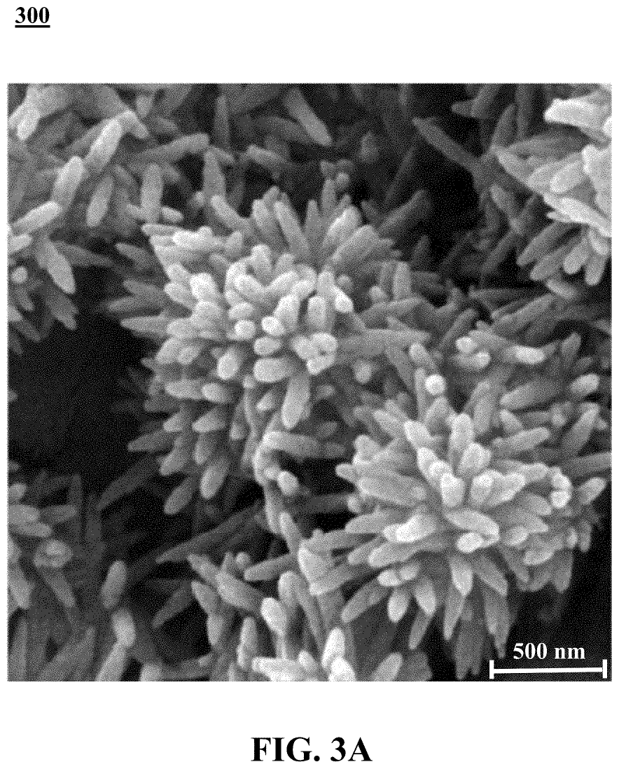

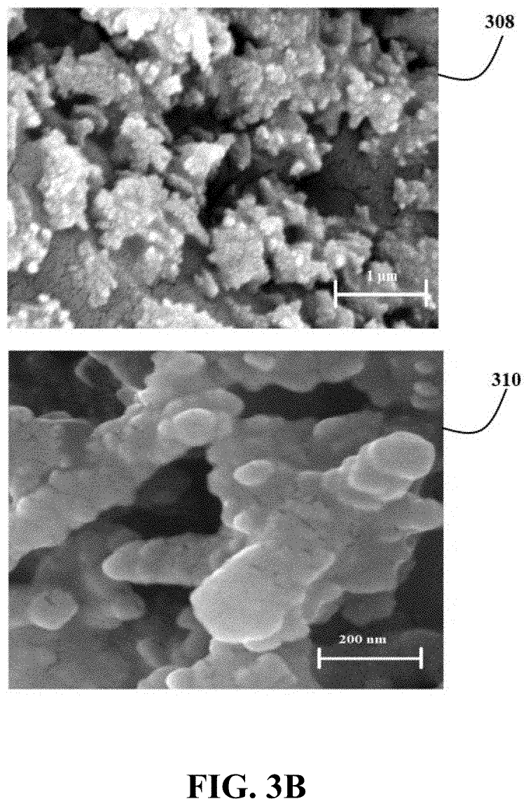

An exemplary process of synthesizing self-assembled nanostructures of Ag/SiO₂ may be carried out using a method similar to method 100. To synthesize self-assembled nanostructures of Ag/SiO₂ with a flower shape, core/shell nanostructure of Ag/SiO₂ may be added to water for 2-4 minutes to 10 minutes. An exemplary colloidal solution of Ag/SiO₂ in water may be homogenized using an ultrasonic device during adding Ag/SiO₂ to water. An exemplary colloidal solution of Ag/SiO₂ in water may be homogenized using the ultrasonic device after adding Ag/SiO₂ to water for 1 minute to 3 minutes. An exemplary concentration of Ag/SiO₂ in water may be in a range of 1 w/w % to 12 w/w %. FIG. 3A shows a scanning electron microscopy (SEM) image 300 of flower-shaped Ag/SiO₂ nanostructures on a fabric, consistent with one or more exemplary embodiments of the present disclosure. As shown in FIG. 3A, flower-shaped Ag/SiO₂ nanostructures were produced using Ag nanoparticles and SiO₂ nanoparticles. To form flower-shaped Ag/SiO₂ nanostructures, SiO₂ nanoparticles with negative zeta potential in water media may be interacted to Ag nanoparticles with positive zeta potential in water. Ag nanoparticles may cover partial space of an exemplary outer surface of SiO₂ nanoparticles. Therefore, positive Ag nanoparticles may absorb SiO₂ nanoparticles and a chain of SiO₂ nanoparticles may be formed. Positively charged Ag nanoparticles may be absorbed to negatively-charged SiO₂ nanoparticles via electrostatic and columbic interactions. This disclosure may also satisfy a green, fast, purification-free, easy-scalable, ready-to-use colloidal delivery, toxinless, water-based, chemical-free, fully clean, surfactant-free, one-pot, and single-step technique. Accordingly, the present method is also efficient to produce sustainable, biomimetic, challenging, bio-inspired, photocatalysts, bioactive, and biocompatible nanostructures which may satisfy synergistic features also with direct and indirect green approaches.

### Example 2: Synthesizing Star-Shaped TiO₂/Ag/SiO₂

An exemplary process of synthesizing self-assembled nanostructures of TiO₂/Ag/SiO₂ may be carried out using a method similar to method 108. To synthesize self-assembled nanostructures of TiO₂/Ag/SiO₂ with a star shape, core/shell structure of Ag/SiO₂ may be added to water. Ag/SiO₂ concentration in water may be in a range of 0.5 w/w % to 20 w/w %. An exemplary colloidal solution of Ag/SiO₂ in water may be homogenized using an ultrasonic device during adding Ag/SiO₂ to water. After homogenizing an exemplary colloidal solution of Ag/SiO₂ in water, TiO₂ nanoparticles with a weight ratio in a range of 1:0.1 to 1:1.5 (Ag/SiO₂:TiO₂) may be added to the colloidal solution of Ag/SiO₂. An exemplary colloidal solution of TiO₂/Ag/SiO₂ in water may be homogenized using the ultrasonic device during adding TiO₂ nanoparticles for 30 seconds to 30 minutes. An exemplary colloidal solution of TiO₂/Ag/SiO₂ in water may be homogenized using the ultrasonic device after adding TiO₂ to water for 1 second to 10 minutes. Exemplary TiO₂ nanoparticles may include 80% anatase and 20% rutile phase with an average size of 25 nm. An exemplary solution of TiO₂/Ag/SiO₂ may be produced in a time period of less than 14 minutes. An exemplary concentration of Ag/SiO₂ in water may be in a range of 2 w/w % to 7 w/w %. In an exemplary embodiment, the weight percent of the TiO₂ nanoparticles may be equal to the weight percent of Ag/SiO₂ nanoparticles in water. FIG. 3B shows SEM images of star-shaped self-assembled TiO₂/Ag/SiO₂ nanostructures on a fabric, consistent with one or more exemplary embodiments of the present disclosure. In an exemplary embodiment, FIG. 3B shows a SEM image 308 of star-shaped self-assembled nanostructures on a fabric and a magnified SEM image 310 of exemplary self-assembled star-shaped self-assembled nanostructures. With regards to SEM image 308, TiO₂ nanoparticles with negative zeta potential were interacted to positively charged Ag nanoparticles. TiO₂ nanoparticles can partially hinder chain growth of SiO₂ nanoparticles. Therefore, star-shaped self-assembled nanostructures can be formed. The flower-shaped and the star-shaped nanostructures deposited on a fabric surface show the shape-stability of the self-assembled nanostructures through a fabric treatment even under a padding pressure process. Creating a nano-jagged morphology covering the surface of the fabric with nano-serration and nano-denticles may drive frequent irregular internal multi-reflection and multi-refraction phenomena into and between the resin shell and/or self-assembled nanostructures. The frequent irregular internal multi-reflection and multi-refraction phenomena may also efficiently be used to control reflection, refraction, etc., to achieve particular optical features, acoustics properties, degradation or synthesis efficiency, etc.

### Example 3: Functionalizing Fabrics Using Star-Shaped TiO₂/Ag/SiO₂ and Flower-Shaped Ag/SiO₂ Nanostructures

In this example, a method similar to method 114 may be used to functionalize fabrics using exemplary formed self-assembled inorganic nanostructures, for example, star-shaped TiO₂/Ag/SiO₂ self-assembled nanostructures and/or flower-shaped Ag/SiO₂ self-assembled nanostructures formed according to EXAMPLEs 1 and 2 described hereinabove. Exemplary fabrics may be washed using an aqueous solution of a detergent. A non-ionic detergent was used to wash exemplary fabrics with a concentration of 5 g/L at 60° C. for 30 minutes. After washing exemplary fabrics with the detergent solution, exemplary fabrics may be washed with water at 40° C. for 5 minutes. Exemplary fabrics may be placed in a container filled with one of the colloidal solution of TiO₂/Ag/SiO₂ nanostructures and the colloidal solution of Ag/SiO₂ nanostructures. Exemplary fabrics may be immersed into the one of the colloidal solution of TiO₂/Ag/SiO₂ nanostructures and the colloidal solution of Ag/SiO₂ nanostructures for at least 3 seconds commonly 3 to 20 seconds. Exemplary fabrics may be picked up with a wet-pick-up percent of 50% to 120%. In this example, to dry the functionalized fabric, different methods may be used such as a drying process, e.g. in a stenter, a heater, an oven, using IR, UV, irradiation, etc. and/or at predetermined condition or combinations thereof. Drying in a dryer at higher temperatures than predetermined temperature may be pursued depending on the fabric thermal resistance and it is commonly between 50° C. and 200° C. Before drying the fabric, a resin layer may be spray coated on the nanofunctionalized fabric. The process may be a continuous treatment of the nanofunctionalized fabric, for example using an integrated process of spraying to padding in a dip-pad-spray-dry process. The spray rate may be set to reach 10% to 200% wet-pick-up based on the dry fabric commonly 50% to 100% with all above mentioned possibility. In a case when the resin may be used, exemplary fabrics may be immersed into the resin for 3 seconds to 10 seconds with a wet-pick-up of 50% to 120%. The resin treatment may be performed via spray method after the drying process. Spray rate may be set to reach 10% to 200% wet-pick-up based on the dry fabric. The wet-pick-up may be commonly 50% to 100% with all mentioned possibility. A drying process may be performed in for example, a stenter, a heater, an oven, using IR, UV, irradiation, etc. and/or at predetermined condition or combination thereof. Drying in a dryer at higher temperatures than predetermined temperatures may be pursued depending on the fabric thermal resistance (between 50° C. and 200° C.). Dry-cure, UV, optical, IR curing, and their combination may be used when using reactive agents including curable resins, curing agents, and self-crosslinkable resins even at predetermined conditions. Additives may be added to an exemplary resin, the additives may be one of dendrimers, capsules, cyclodextrin, liposomes, macromolecules, superstructures, frameworks MOFs, ion, molecules, salts, surfactants, electrolytes, drugs, dyes, softeners, antistatic, flame-retardants, anti-crease agents, dye, drug, biomaterials, vitamins, etc., and also their derivatives and/or functionalized materials, and combinations thereof. An exemplary additive may be added into, before and/or after each of the steps of above mentioned scenarios for instance as a mixture with resin in fabric treatment and/or as mixture and/or a coating or shell on the produced self-assembled nanostructures, and/or as a post treatment, etc. The self-assembled nanostructures may be used in an encapsulation process, synthesis of other materials and so on. The process may be pursued using a pure water media with no need for extra additives. The treated fabric may be subjected to any post treatments e.g. dying, printing, pressing, future functionalization, etching, irradiation (e.g. plasma, UV, microwave, etc.), and/or combinations thereof.

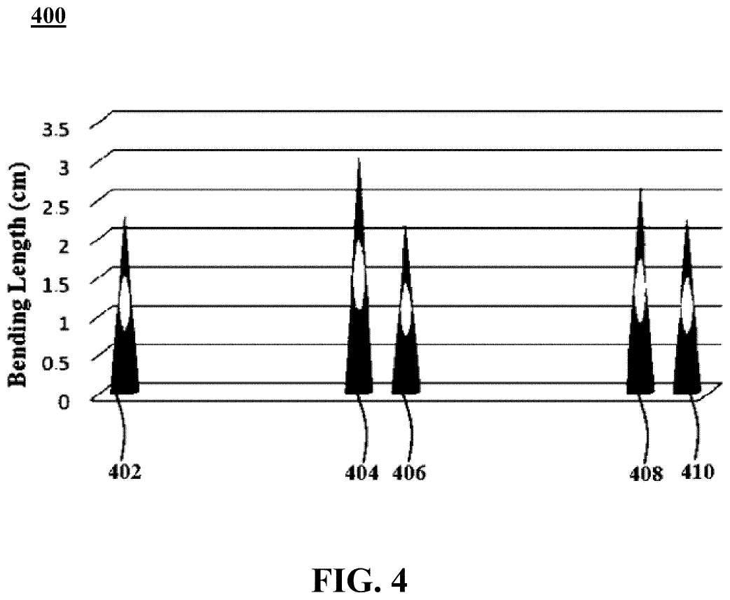

For analyzing bending length of the treated fabrics, a bending test was performed for the treated fabrics and a control fabric. FIG. 4 shows a chart 400 representing results of the bending test applied on the fabrics treated by the colloidal solutions of flower-shaped nanostructures and star-shaped nanostructures, and the control sample, consistent with one or more exemplary embodiments of the present disclosure. As shown in FIG. 4, the bending length of control sample 402, bending length of flower-shaped nanostructure 408, and bending length star-shaped nanostructures 404 are 2.2 cm, 2.6 cm, and 2.9 cm, respectively. The bending length of resin coated star-shaped fabrics 406 and the bending length of resin coated flower-shaped fabrics 410 are 2.0 cm and 2.1 cm, respectively.

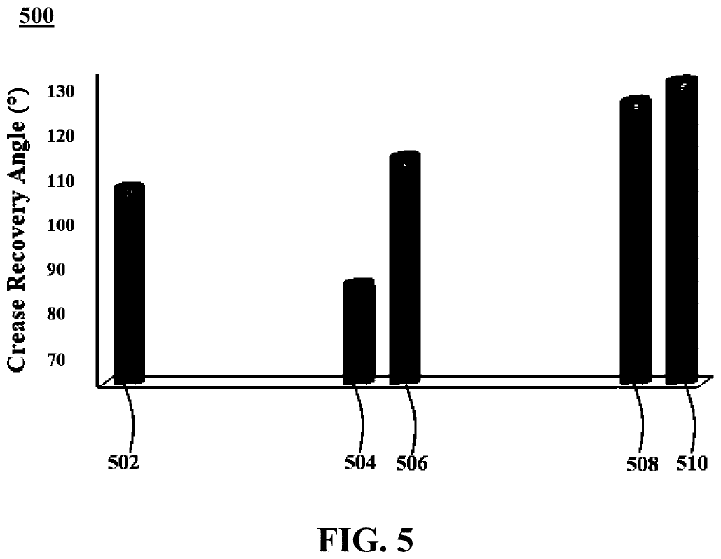

For assessing crease recovery angle of the treated fabrics, a crease recovery angle test was performed for the treated fabrics and a control fabric. FIG. 5 shows a chart 500 representing results of the crease recovery angle test applied on the fabrics treated by the colloidal solutions of flower-shaped nanostructures and star-shaped nanostructures, and the control sample, consistent with one or more exemplary embodiments of the present disclosure. As shown in FIG. 5 the crease recovery angle of control sample 502, the crease recovery angle of flower-shaped nanostructure 508, and the crease recovery angle of star-shaped nanostructures 504 are 110°, 125°, and 90°, respectively. The crease recovery angle of resin coated star-shaped fabrics 506 and the crease recovery angle of resin coated flower-shaped fabrics 510 are 120° and 130°, respectively.

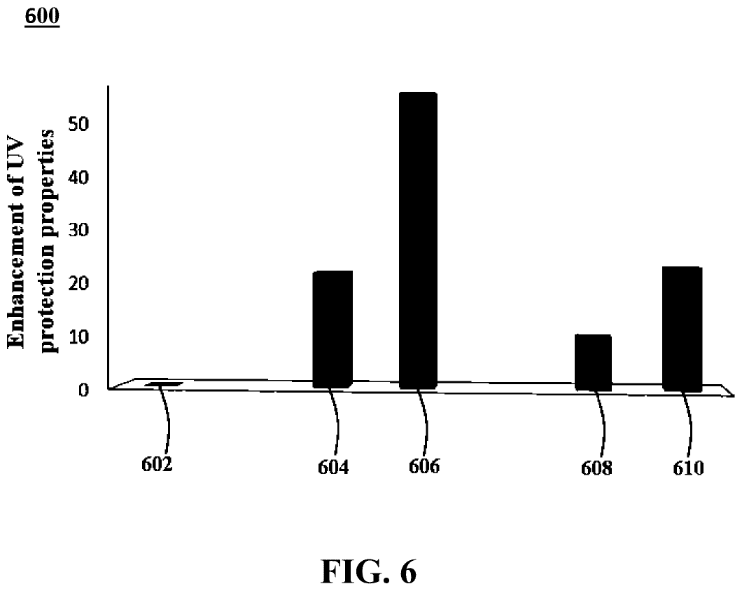

For assessing enhancement of UV protection properties of the treated fabrics, a UV protection test was performed for the treated fabrics and a control fabric. FIG. 6 shows a chart 600 representing results of the UV protection test applied on the fabrics treated by the colloidal solutions of flower-shaped nanostructures and star-shaped nanostructures, and the control sample, consistent with one or more exemplary embodiments of the present disclosure. As shown in FIG. 6 the enhancement of UV protection properties of control sample 602, the enhancement of UV protection properties of flower-shaped nanostructure 608, and the enhancement of UV protection properties of star-shaped nanostructures 604 are 0%, 10%, and 20%, respectively. The enhancement of UV protection properties of resin coated star-shaped fabrics 606 and the enhancement of UV protection properties of resin coated flower-shaped fabrics 610 are 55% and 25%, respectively.

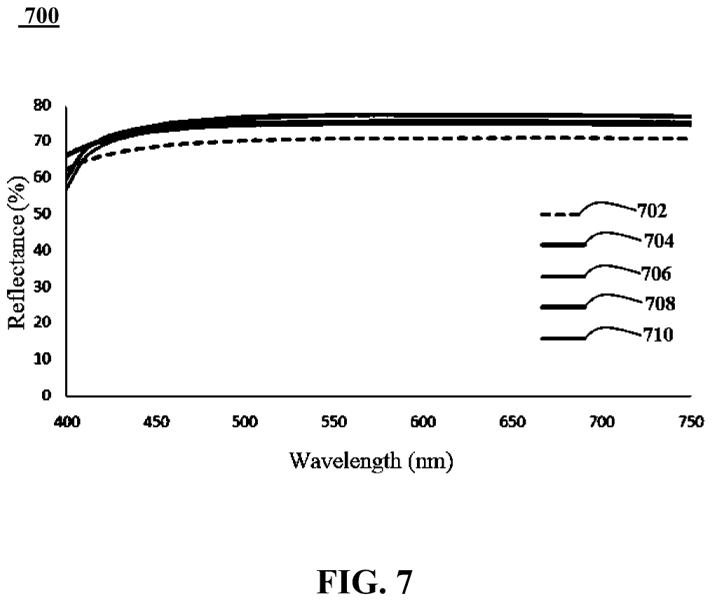

For assessing reflectance of the treated fabrics, a reflectance assessment test was performed for the treated fabrics and a control fabric. FIG. 7 shows a chart 700 representing results of the reflectance assessment test applied on the fabrics treated by the colloidal solutions of flower-shaped nanostructures and star-shaped nanostructures, and the control sample, consistent with one or more exemplary embodiments of the present disclosure. As shown in FIG. 7 the reflectance of flower-shaped nanostructure 708, the reflectance of resin coated flower-shaped nanostructures 710, the reflectance of resin coated star-shaped nanostructures 706, and the reflectance of star-shaped nanostructures 704 are higher/equal to the reflectance of control sample 702. The results show that the treatments have no side effects on the optical properties and whiteness of the fabric.

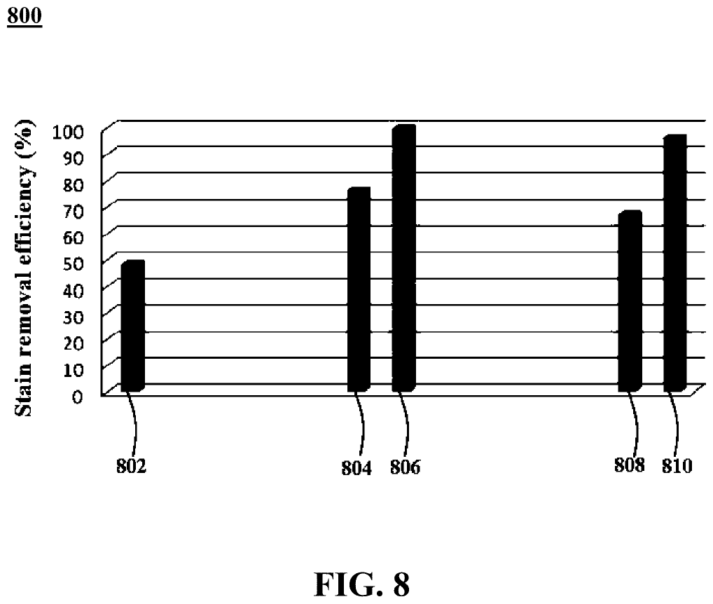

For assessing stain removal efficiency of the treated fabrics, a stain removal assessment test was performed for the treated fabrics and a control fabric. FIG. 8 shows a chart 800 representing results of the stain removal assessment test applied on the fabrics treated by the colloidal solutions of flower-shaped nanostructures and star-shaped nanostructures, and the control sample, consistent with one or more exemplary embodiments of the present disclosure. As shown in FIG. 8 the stain removal efficiency of control sample 802, the stain removal efficiency of flower-shaped nanostructure 808, and the stain removal efficiency of star-shaped nanostructures 804 are 45%, 65%, and 75%, respectively. The stain removal efficiency of resin coated star-shaped fabrics 806 and the stain removal efficiency of resin coated flower-shaped fabrics 810 are 98% and 93%, respectively. In an exemplary embodiment, intense charge density on the sharp edges increase the chance of electron interactions between nanostructures and the resin especially amino-functional resins. Forming a magnifier lens especially by the silicon resins as well as sub 10-nm gaps at merging sites may activate an induce electron transfer system too. The treated fabrics with such features may be used in biomimetic photocatalytic activities, biomedicine, medical engineering, tissue engineering, and regenerative biomedicine, such as masks, industry, home, hospital textiles and clothes, etc. Such treatments may be used for simultaneous water-less self-disinfecting, self-cleaning, antiviral, antimicrobial comfortable hospital's textiles, frequent-usable or non-disposable masks, gown, and protective clothes. Superior features of an intelligent boosted antimicrobial activity (smartly activated by raising humidity), local multi-intelligent action on a hydrophobic bioactive surface considering prevention of penetration pollutions, forming a magnifier lens by a microbial droplet and accelerating fast local self-disinfection. Effect of humidity on the activity of metal-based bioactive agents such as Ag NPs may run an intelligent activity, besides a photocatalysts, and since it is an indirect mechanism it is supposed to prevent genetic mutation risk for both photocatalysts and metals. This feature may be used for biomimetic photocatalytic air, water waste-water treatments, etc.

The treated fabrics may show a distinct wetting property. The resin layer is hydrophobic and the flower-shaped nanostructures and the star-shaped nanostructures are hydrophilic. In this example an aminofunctionalized polysiloxane resin with specific properties such as, self-cross linkable fluorine-free, UV-transparent, permeable to air and oxygen, and resistant to numerous chemicals was used. Therefore, water droplets may need time for 2 minutes to 4 minutes to penetrate into the nanostructure surface. Hence, the treated fabrics may show high stain removal efficiency. Such features may be considered for comfortable stain-repellent and concurrently soil-release performance. On the other hand, achieving such high droplet absorption time of more than 2000 seconds for some other treated fabrics may be considered for coatings which are highly resistant to liquid penetration and/or omniphobic coatings. Such features may be also used for dual controlled drug delivery for smart and multi-purpose targeting therapies, antiadhesive wound bandages, and other antiadhesive membranes such as cardiovascular applications especially pericardial substitutes also in other demands such as prevention of postoperative peritoneal adhesions in intra-abdominal surgeries, and so on, blood-repellent and/or comfortable protective garments, and other biomedical approaches, also for epidermolysis bullosa (EB) patient's garments, etc., as well as numerous superhydrophobic demands from daily stain-repellent garments to industrial blankets for food transfer in food industries to a substrates for ionic liquid or ionic solution flow, etc. Table 1 illustrates water absorbance efficiency of the treated fabrics using 10 μL water, consistent with one or more exemplary embodiments of the present disclosure. The resin treated fabrics were evaluated after 50 cycles of laundry according to AATCC test for 45 minutes at 60° C. with 5 g/L standard soap to concurrently test washing fastness at a liquor ratio of 80:1 (liquid:fabric). As used herein an exemplary AATCC test is a quantitative standard test method for evaluating fabric antibacterial activities.

TABLE 1
Water absorbance time of the treated fabrics using a 10 μL water droplet.

| | Treated by flower- | Treated by flower- | | 10 μL water |
|---|---|---|---|---|
| Sample | shaped nanostructures | shaped nanostructures | Resin | absorbance (s) |
| control | − | − | − | Instantly |
| Flower | + | − | | Instantly |
| Flower-resin (1.7%) | + | | + | 701 |
| Flower-resin | + | | + | 2474(spray) |
| (2.2-3.5%) | | | | 2497(pad) |
| Flower-resin (1%) | + | | + | 222 |
| star | | + | | Instantly |
| Star-resin (1.7%) | | + | + | 413 |
| Star-resin | | + | + | 2258 (spray) |
| (2.2-3.5%) | | | | 2270(pad) |
| Star-resin (1%) | | + | + | 167 |

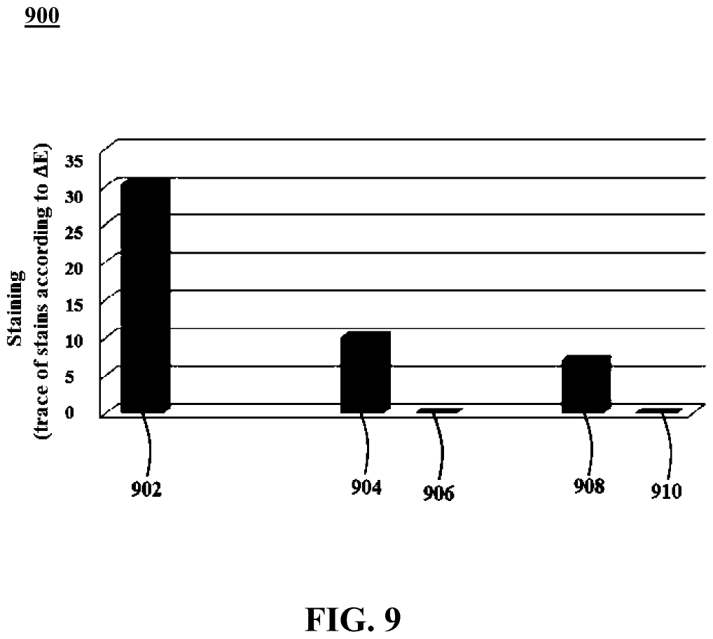

For assessing stain repellency of the treated fabrics, a test for measuring the trace of stain via ΔE was performed for the treated fabrics and a control fabric. FIG. 9 shows a chart 900 representing results of the staining assessment test applied on the fabrics treated by the colloidal solutions of flower-shaped nanostructures and star-shaped nanostructures, and the control sample, consistent with one or more exemplary embodiments of the present disclosure. FIG. 9 shows staining of untreated fabric (control sample), and the staining of 50-times washed resin treated fabrics functionalized with the colloidal solutions of flower-shaped nanostructures and star-shaped nanostructures. As shown in FIG. 9 the staining (ΔE) of control sample 902, the staining of flower-resin (1.7%) 908, and the staining of star-resin (1.7%) 904 are 29, 7, and 9, respectively. The staining of fabrics treated by star-resin (2.2-3.5%) 906 and the staining of flower-resin (2.2-3.5%) 910 are near zero.

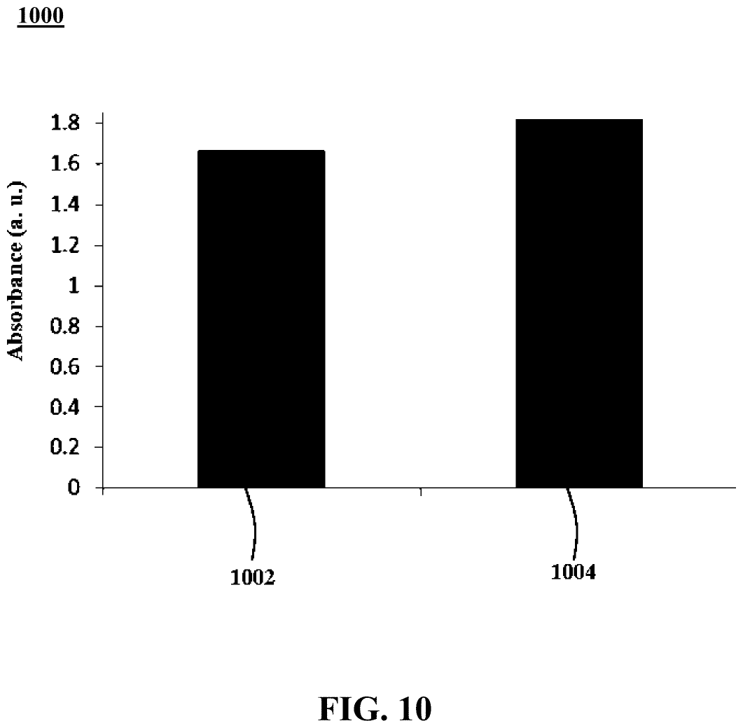

For assessing biocompatibility of the treated fabrics, an MTT test was performed for the treated fabrics and in comparison with a control sample. In an exemplary embodiment, an exemplary control sample is a tissue culture polystyrene (TCPS). As used herein an exemplary MTT test is a test for evaluating cell viability. FIG. 10 shows a chart 1000 representing results of the biocompatibility test applied on the fabrics treated by the colloidal solutions of nanostructures, and the control sample, consistent with one or more exemplary embodiments of the present disclosure. As shown in FIG. 10 the absorbance of nanofunctionalized fabric 1004 shows a good biocompatibility even more than the absorbance of control sample of tissue culture polystyrene (TCPS) 1002. A value of absorbance (as a criterion for cell viability) for tissue culture polystyrene (TCPS) and absorbance for nanofunctionalized fabric 1004 treated by the inorganic nanostructures were 1.65 and 1.8, respectively.

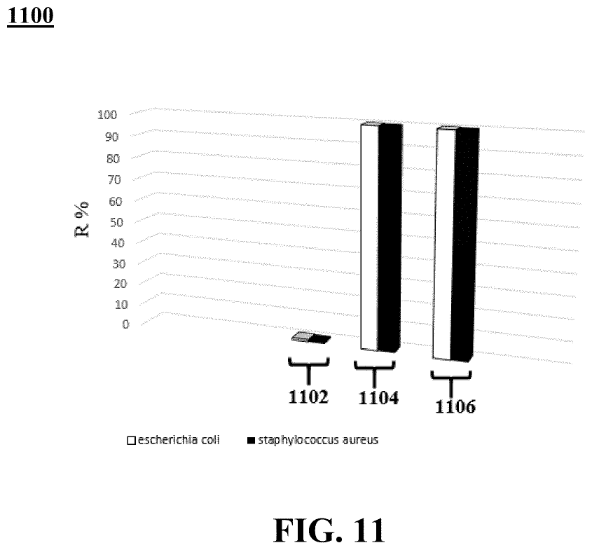

Staphylococcus aureus (positive gram bacteria) and Escherichia coli (negative gram bacteria) were used to assess antibacterial activity of flower-shaped nanostructures and star-shaped nanostructures. For assessing an antibacterial activity of flower-shaped nanostructures and star-shaped nanostructures in the treated fabrics, an AATCC 100 test was performed for the treated fabrics and a control fabric. To evaluate the performance of the applied resin to fix self-assembled nanostructures on a fabric, some characterizations such as wetting behavior, antimicrobial activity stain removal efficiency and self-cleaning tests were performed after subsequent washing cycles to satisfy 50-cycles home laundering according to the AATCC 61(2A) test to concurrently test the washing fastness of resin-treated fabrics. Each washing process followed for 45 minutes at a temperature of 60° C. with 5 g/L of standard soap powder with 80:1 (Liquid:fabric) with metal balls. In addition, the concentrations of titanium and silver ions leach out in the collected washing effluents were analyzed employing ICP-OES (Inductively coupled plasma optical emission spectroscopy) as a criterion of the washing fastness. The results recording the amount of titanium and silver ions released in washing were less than 1 and 2% of nanostructures contents in total washing effluents, which led to the calculation of fastness above 98 and 99%. An exemplary fabrics are coated with a resin. FIG. 11 shows a chart 1100 representing results of the antibacterial activity test applied on the fabrics treated by the colloidal solutions of flower-shaped nanostructures and star-shaped nanostructures, and the control sample, consistent with one or more exemplary embodiments of the present disclosure. As shown in FIG. 11 the biocompatibility of control sample 1102 and the biocompatibility of a sample treated by the flower-shaped nanostructures 1104 and the biocompatibility of a star-shaped nanostructures 1106 show antibacterial activity of about 100%. Antibacterial activity of 50-times washed resin treated samples functionalized by the flower-shaped 1104 and star-shaped nanostructures 1106 are about 100% in comparison to the antibacterial activity of control (untreated) sample 1102.

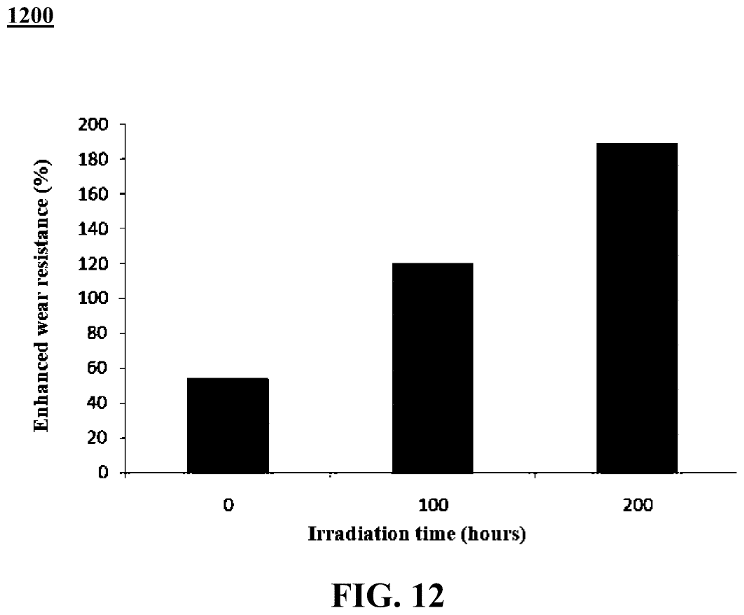

For assessing the wear resistance of resin-treated fabric functionalized by colloidal solution of exemplary formed self-assembled nanostructures under the sun radiation, a wear resistance test was applied. For assessing the resistance of the resin-treated nanofunctionalized fabrics to the sun radiation and also evaluating the wear resistance of the fabrics, an abrasion resistance test was performed. FIG. 12 shows a chart 1200 representing results of the wear resistance test applied on the fabrics treated by the colloidal solutions of formed self-assembled nanostructures before sun radiation and after sun radiation, consistent with one or more exemplary embodiments of the present disclosure. As shown in FIG. 12 enhanced wear properties of the treated samples in comparison with the enhanced wear properties of untreated samples were recorded before and after irradiation. The treated fabrics show enhanced wear resistance after irradiation. The wear resistance of 100 h irradiated treated fabrics was even better than un-irradiated treated fabrics as well as un-irradiated control fabrics. The nanocomposite layer formed on the fabrics may function as a protective layer. Nanostructures can absorb the sun light and protect fabrics form harmful effects of the light radiation. The active functions made by sun radiation may also provide functions to link resin, nanostructures and fabric surfaces. The polysiloxane resin also have a self-healing feature. The combination of the activated polymer and nanostructures may also show self-healing properties.

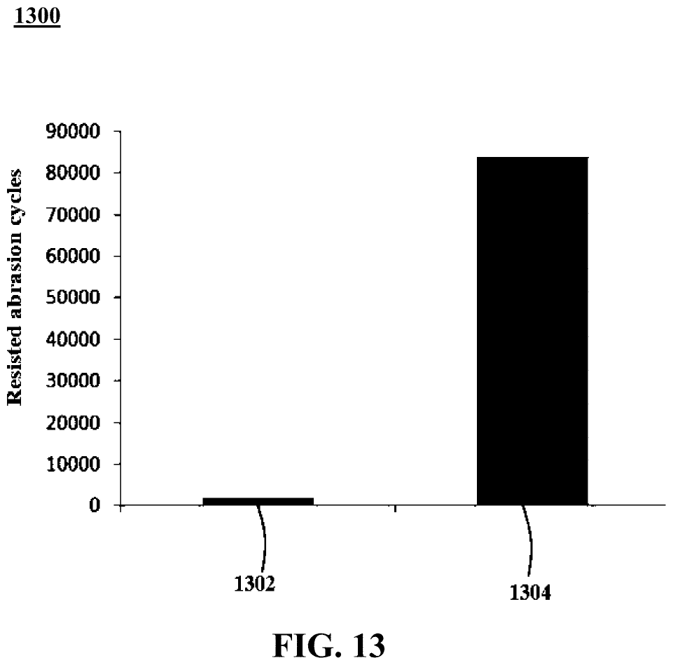

For assessing resistant abrasion cycles of exemplary resin-treated fabric functionalized with colloidal solution of exemplary formed self-assembled nanostructures, a resistant abrasion cycle test was applied. In this example, an exemplary fabric is resin-coated chenille fabric functionalized with colloidal solution of exemplary formed self-assembled nanostructures. FIG. 13 shows a chart 1300 representing results of the resistant abrasion cycle test applied on the fabrics treated by the colloidal solution of nanostructures and the fabrics with no treatment, consistent with one or more exemplary embodiments of the present disclosure. As shown in FIG. 13 resistant abrasion cycles for an exemplary treated fabric with colloidal solution of nanostructures are more than 80000 cycles, whereas resistant abrasion cycles for an exemplary fabric with no treatment are less than 2000 cycles.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A method for forming self-assembled inorganic nanostructures, the method consisting:
forming a first mixture by adding a plurality of inorganic nanostructures to an aqueous solution at a weight ratio in a range of 0.001:100 to 40:100 (the plurality of inorganic nanostructures: the aqueous solution), comprising:
adding a first plurality of inorganic nanostructures of a metal, a metal oxide, a metal hydroxide, Silicon (Si), Boron (B), Silicon dioxide (SiO₂), a salt, a composite, clays, layered double hydroxides (LDHs), MXenes, magnetites, graphene, graphene oxide, reduced graphene oxide, carbon nanotubes (CNTs), fullerene, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof to the aqueous solution at atmospheric pressure and a temperature of at least 2° C.; and
adding a second plurality of inorganic nanostructures comprising a second plurality of superficial sites with opposite-signed surface zeta potential respective to a surface zeta potential of a first plurality of superficial sites of the first plurality of inorganic nanostructures to the aqueous solution at the predetermined condition, the second plurality of inorganic nanostructures comprising at least one of a metal, a metal oxide, a metal hydroxide, Silicon (Si), Boron (B), Silicon dioxide (SiO₂) a salt, a composite, clays, layered double hydroxides (LDHs), MXenes, magnetites, graphene, graphene oxide, reduced graphene oxide, carbon nanotubes (CNTs), fullerene, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof.

2. The method of claim 1, wherein adding the first plurality of inorganic nanostructures to the aqueous solution comprises adding the first plurality of inorganic nanostructures to at least one of distilled water, deionized water, municipal water, water with total dissolved solids (TDS) of between 1 ppm and 50000 ppm, recycled water, and combinations thereof.

3. The method of claim 1, wherein forming the first mixture further comprises homogenizing the first mixture at the predetermined condition utilizing an ultrasonic device with a sonication power of at least 5 kJ for at least 10 seconds.

4. The method of claim 1, further comprising:
forming a second mixture by adding a third plurality of inorganic nanostructures to the first mixture at a concentration of at least 5 ppm at a predetermined condition, the third plurality of inorganic nanostructures comprising a plurality of at least one of a metal, a metal oxide, a metal hydroxide, Silicon (Si), Boron (B), Silicon dioxide (SiO₂), a salt, a composite, clays, layered double hydroxides (LDHs), MXenes, magnetites, graphene, graphene oxide, reduced graphene oxide, carbon nanotubes (CNTs), fullerene, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof, the third plurality of inorganic nanostructures comprising a third plurality of superficial sites with opposite-signed surface zeta potential respective to a surface zeta potential of the at least one of the first plurality of superficial sites and the second plurality of superficial sites.

5. The method of claim 4, wherein the metal comprises at least one of Silver (Ag), Copper (Cu), Platinum (Pt), Gold (Au), Manganese (Mn), Tin (Sn), Iron (Fe), Lead (Pb), Iridium (Ir), Cobalt (Co), Tellurium (Te), Nickel (Ni), Niobium (Nb), Vanadium (V), Tungsten (W), and combinations thereof.

6. The method of claim 4, wherein the metal oxide and the metal hydroxide comprise at least one of Titanium dioxide (TiO₂), Zinc oxide (ZnO), Copper oxide (CuO), Iron oxide (Fe₂O₃), Iron oxide (Fe₃O₄), Magnesium oxide (MgO), Magnesium hydroxide (MgOH), and combinations thereof.

7. The method of claim 4, wherein the salt comprises at least one of Calcium carbonate (CaCO₃), Silicon carbide (SiC), Iron phosphorus trisulfide (FePS₃), Strontium stannate (SrSno₃), Tungsten ditelluride (WTe₂), Potassium heptafluorotantalate (K₂TaF₇), Tungsten disulfide (WS₂), Magnesium diboride (MgB₂), Niobium disulfide (NbS₂), transition metal chalcogenides (TMCs), and combinations thereof.

8. The method of claim 4, wherein the composite comprises at least one of Silver/Zinc oxide (Ag/ZnO), Silver/Silicon dioxide (Ag/SiO₂), Silver/Titanium dioxide (Ag/TiO₂), and combinations thereof.

9. The method of claim 4, wherein forming the second mixture further comprises homogenizing the third plurality of inorganic nanostructures within the first mixture, utilizing an ultrasonic device with a sonication power of at least 5 kJ for at least 10 seconds.

10. A method for nanofunctionalizing a fabric with inorganic nanostructures, comprising:
forming a mixture of a plurality of self-assembled inorganic nanostructures, comprising adding a plurality of inorganic nanostructures to an aqueous solution at a weight ratio in a range of 0.001:100 to 40:100 (the plurality of the inorganic nanostructures: the aqueous solution), comprising:
adding a first plurality of inorganic nanostructures of at least one of a metal, a metal oxide and a metal hydroxide, Silicon (Si), Boron (B), Silicon dioxide (SiO₂), a salt, a composite, clays, layered double hydroxides (LDHs), MXenes, magnetites, carbon nanotubes (CNTs), fullerene, graphene, graphene oxide, reduced graphene oxide, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof to the aqueous solution at atmospheric pressure and a temperature of at least 2° C.; and
adding a second plurality of inorganic nanostructures comprising a second plurality of superficial sites with opposite-signed surface zeta potential respective to a surface zeta potential of a first plurality of superficial sites of the first plurality of inorganic nanostructures to the aqueous solution at the predetermined condition, the second plurality of inorganic nanostructures comprising at least one of a metal, a metal oxide, a metal hydroxide, Silicon (Si), Boron (B), Silicon dioxide (SiO₂), a salt, a composite, clays, layered double hydroxides (LDHs), MXenes, magnetites, carbon nanotubes (CNTs), fullerene, graphene, graphene oxide, reduced graphene oxide, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof;
depositing the plurality of self-assembled inorganic nanostructures on a fabric by immersing the fabric into the mixture of the plurality of self-assembled inorganic nanostructures for at least 3 seconds;
retaining moisture of the fabric in the mixture at a wet-pick-up percent in a range of 10% to 350%; and
drying the fabric in a heater at a temperature of between 20° C. and 200° C. for at least 30 seconds.

11. The method of claim 10, wherein at least one of adding the first plurality of inorganic nanostructures to the aqueous solution and adding the second plurality of inorganic nanostructures to the aqueous solution further comprises homogenizing the aqueous solution containing the added first plurality of inorganic nanostructures and/or the added second plurality of inorganic nanostructures using an ultrasonic device with a sonication power of at least 5 kJ for at least 10 seconds at the predetermined condition.

12. The method of claim 10, wherein immersing the fabric into the mixture of the plurality of self-assembled inorganic nanostructures comprises loading the plurality of self-assembled inorganic nanostructures to the fabric at a weight ratio in a range of 0.001:100 to 300:100 (the plurality of self-assembled inorganic nanostructures: the fabric).

13. The method of claim 10, further comprises coating the nanofunctionalized fabric with a resin, comprising:
depositing a resin on the nanofunctionalized fabric by immersing the nanofunctionalized fabric into the resin, the resin comprising at least one of acrylic resins, silicones, polysiloxanes, polyurethanes, poly(vinyl acetates) (PVA), polyvinylpyrrolidone (PVP), polyamide (PA), polyethylene oxide (PEO), polyols, n-methylols, polyesters, protein compounds, polysaccharides, carbohydrates, polyelectrolytes, hydrogels, poly(sodium acrylate), polyimide, poly(amidoamine) (PAMAMs), polyaniline, polyvinylidene fluoride (PVdF), and combinations thereof;
retaining the resin on the nanofunctionalized fabric with a wet-pick-up percent in a range of 10% to 300%; and
drying the nanofunctionalized fabric coated with the resin in a heater at a temperature of between 20° C. and 200° C. for at least 30 seconds.

14. The method of claim 13, wherein depositing the resin on the nanofunctionalized fabric comprises immersing the nanofunctionalized fabric into the resin for at least 1 seconds.

15. The method of claim 13, wherein depositing the resin on the nanofunctionalized fabric comprises coating the nanofunctionalized fabric with the resin at a weight ratio of 0.03:100 to 50:100 (the resin: the nanofunctionalized fabric).

16. The method of claim 10, further comprises coating the nanofunctionalized fabric with a resin, comprising:
spray coating the nanofunctionalized fabric with the resin for at least 0.2 s.

17. The method of claim 16, wherein spray coating the nanofunctionalized fabric with the resin comprises spray coating the nanofunctionalized fabric with a resin solution at a weight ratio in a range of 0.0003:1 to 2:1 (resin:solvent).

18. The method of claim 10, wherein forming the mixture of the plurality of self-assembled inorganic nanostructures further comprises:
adding a third plurality of inorganic nanostructures to the aqueous solution at a concentration of at least 5 ppm at the predetermined condition, the third plurality of inorganic nanostructures comprising a plurality of at least one of a metal, a metal oxide, a metal hydroxide, Silicon (Si), Boron (B), Silicon dioxide (SiO₂), a salt, a composite, clays, layered double hydroxides (LDHs), MXenes, magnetites, carbon nanotubes (CNTs), fullerene, graphene, graphene oxide, reduced graphene oxide, metal-organic frameworks (MOFs), hexagonal boron nitride (hBN), borophene, bismuth strontium calcium copper oxide (BSCCO), kagome lattices, bis(ethylenedithio)tetraselenafulvalene (BETS) metal compounds, hydroxyapatite, and combinations thereof, the third plurality of inorganic nanostructures comprising a third plurality of superficial sites with opposite-signed surface zeta potential respective to a surface zeta potential of at least one of the first plurality of superficial sites and the second plurality of superficial sites.

19. The method of claim 18, wherein adding the third plurality of inorganic nanostructures to the aqueous solution further comprises homogenizing the third plurality of inorganic nanostructures within the aqueous solution utilizing an ultrasonic device with a sonication power of at least 5 kJ for at least 10 seconds.

20. The method of claim 10, wherein adding the plurality of inorganic nanostructures to the aqueous solution comprises adding the plurality of inorganic nanostructures to at least one of distilled water, deionized water, municipal water, water with total dissolved solids (TDS) of between 1 ppm and 50000 ppm, recycled water, and combinations thereof.
